(19) United States
(12) Patent Application Publication
(10) Pub. No.: US 2004/0155878 A1
(43) Pub. Date: Aug. 12, 2004

(54) Image processing method, image processing device, and image processing program

(75) Inventor: Mitsuhiro Inazumi, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 10/724,132

(22) Filed: Dec. 1, 2003

(30) Foreign Application Priority Data
Dec. 3, 2002 (JP) 2002-351458

(51) Int. Cl. G06T 17/20

(52) U.S. Cl. 345/423

(57) ABSTRACT

Expansion and reduction of images, resolution conversion, and processing for forming only some portions of an image into a higher resolution are made easier, and processing speed is increased, and the size of circuit scale is reduced. An image processing device includes an image data input device to input and store an image, a square-area dividing device to divide the input image into one or more square areas, a recurrent triangular-area dividing device to recurrently divide each of the divided square areas into triangular areas, a triangular-area dividing control device to perform control of recurrent division into triangular areas, a coded data generation device to code the divided triangular areas, and a coded data output device to output the generated coded data. The number of pixels contained in one side of the square area generated by the square-area dividing device is made 2 raised to the N-th power+1 (where N is a natural number).

### BACKGROUND OF THE INVENTION

1. Field of Invention

The present invention relates to an image processing method, an image processing device, and an image processing program. More particularly, the present invention relates to an image processing method, in which an image is formed into a square area, the square area is divided into triangular areas, and image processing is performed on the divided triangular areas, to an image processing device therefor, and to an image processing program therefor.

2. Description of Related Art

In the related art, with the widespread use of the network environment, information having a large amount of data, such as images, is communicated, and such images can be handled in various devices. At present, even for the same image data, it may be advantageous to enhance or optimize the size and the resolution thereof, etc., in such a manner so as to correspond to the capabilities of the output device therefor.

In a case where images are to be sent with low transmission performance communication or a large amount of images are to be browsed, in order to reduce the amount of data or in order to display portions which are meaningful for a user with priority, it may be advantageous to efficiently increase the resolution of only some portions of the image.

Related art technologies related to such demands are disclosed in Japanese Unexamined Patent Application Publication Nos. 9-84002, 9-191409, 11-298897, and 2000-125294.

In the technology described in Japanese Unexamined Patent Application Publication No. 9-84002, as shown in the flowchart of FIG. 1 thereof, an input image is divided into object areas having a predetermined correlation, each of the object areas is approximated with a polygon, and the interior thereof is plane-approximated in a hierarchical manner. This has advantages such that enhanced or optimum resolution can be set for each object which forms the image and that an object which is of interest to a user can be transmitted with priority.

In the technology described in Japanese Unexamined Patent Application Publication No. 9-191409, as shown in the flowchart of FIG. 8 thereof, an image is represented as a set of triangular area planes. For this reason, processing with a relatively small amount of calculations and a relatively small amount of memory is possible, and is advantageous when using it with general-purpose devices and small devices.

In the technology described in Japanese Unexamined Patent Application Publication No. 11-298897, similarly to the JPEG 2000 standard, in the image processing portion, an image is represented by wavelet transform or by octave division of image data represented in the frequency domain, and as shown in FIGS. 2 and 3 thereof, a reduced image is obtained in a recurrent manner by octave division. The combination of the above makes it possible to enhance the partial resolution and the step-wise resolution of the image.

The technology described in Japanese Unexamined Patent Application Publication No. 2000-125294 is similar to the technology described in Japanese Unexamined Patent Application Publication No. 11-298897, and is designed to perform a wavelet transform mainly in hardware. In this case, enhancements in processing speed, etc., can be expected.

### SUMMARY OF THE INVENTION

However, in the technology described in Japanese Unexamined Patent Application Publication No. 9-84002, there are problems in that a large amount of calculations and a large amount of memory are required to extract object areas. Furthermore, the deterioration of the image when the object area extraction fails is very large.

In the technology described in Japanese Unexamined Patent Application Publication No. 9-191409, as shown in FIGS. 7 and 11 thereof, for this image transmission, the coordinates of three vertexes and the image information are necessary, and thus, the amount of information is large. In the worst case, there may be cases in which an amount of data, which is several times as large as the original data, is necessary. Furthermore, in this technology, a partial resolution improvement and a stepwise resolution enhancement are very difficult.

In the technology described in Japanese Unexamined Patent Application Publication No. 11-298897, a very large amount of calculations and memory are required to perform processing. This becomes a very big problem in a general-purpose device or a small information device.

In the technology described in Japanese Unexamined Patent Application Publication No. 2000-125294, the problem when this processing is performed by software is similar to that of the technology described in Japanese Unexamined Patent Application Publication No. 11-298897. Furthermore, when the technology described in Japanese Unexamined Patent Application Publication No. 2000-125294 is performed by hardware, there is a problem of the versatility of the device being deteriorated.

Accordingly, the present invention provides an image processing method, an image processing device, and an image processing program, which are capable of enhancing or optimizing the image size and the resolution in an output device with a less amount of calculations, memory, and data and which are capable of increasing the resolution of a specific portion of an image.

In the present invention, coding and decoding of image data are performed, and it is presupposed that, when the coding and the decoding are performed, an image to be processed is formed into a square. For forming the image into a square, two kinds of techniques are employed in the present invention. One is a technique in which an image to be processed is divided into one or more square areas. Another is a technique in which one square area is generated by transforming an image to be processed into a square.

First, the image processing method of the present invention is discussed. The invention of Aspect 1 to Aspect 3 is an invention related to processing to divide an image to be processed into one or more square areas in order to generate a plurality of square areas and to code each square area thereof, and the invention of Aspect 4 to Aspect 6 is an invention related to decoding therefor. Furthermore, the invention of Aspect 7 to Aspect 9 is an invention related to processing to generate one square area by transforming an image to be processed into a square and to code the one square area, and the invention of Aspect 10 to Aspect 12 is an invention related to decoding therefor.

That is, the invention of Aspect 1 is directed to an image processing method of dividing an image to be processed into one or more square areas, dividing each square area into triangular areas, and coding the divided triangular area. The image processing method includes: an image input step of inputting the image to be processed and storing the image; a square-area dividing step of dividing the input image into one or more square areas; a recurrent triangular-area dividing step of recurrently dividing each divided square area into triangular areas; a coded data generation step of coding the divided triangular areas; and a coded data output step of outputting the generated coded data.

In the image processing method of Aspect 2, in Aspect 1, the number of pixels contained in one side of the square area generated in the square-area dividing step is preferably 2 raised to the N-th power+1 (where N is a natural number).

In the image processing method of Aspect 3, in Aspect 1 or 2, the recurrent triangular-area dividing step includes a shape type storing step of storing the type of the shape of a triangular area, a vertex pixel information storing step of storing the pixel information of the vertexes and the hypotenuse midpoint of the triangular area, a hypotenuse midpoint pixel information obtaining step of obtaining the pixel information of the hypotenuse midpoint of the triangular area, a shape type updating step of updating the type of the shape of the triangular area, and a vertex pixel information updating step of updating the pixel information of the vertexes and the hypotenuse midpoint of the triangular area.

The image processing method of Aspect 4 is an image processing method of recurrently dividing each square area of an image which is divided into one or more square areas into triangular areas and decoding the coded data obtained by coding the divided triangular areas. The image processing method includes: a coded data input step of inputting the coded image data; a coded data analysis step of analyzing the input coded data; a recurrent triangular-area combining step of recurrently combining triangular areas on the basis of the analyzed coded data; a square-area combining step of combining a square area on the basis of the combined triangular areas; and an image data output step of reconstructing the image data from the combined square area and outputting the image data.

In the image processing method of Aspect 5, in Aspect 4, the number of pixels contained in one side of the square area generated in the square-area combining step is preferably 2 raised to the N-th power+1 (where N is a natural number).

In the image processing method of Aspect 6, in Aspect 4 or 5, the recurrent triangular-area combining step includes a shape type storing step of storing the type of the shape of a triangular area, a vertex pixel information storing step of storing the pixel information of the vertexes and the hypotenuse midpoint of the triangular area, a hypotenuse midpoint pixel information obtaining step of obtaining the pixel information of the hypotenuse midpoint of the triangular area, a shape type updating step of updating the type of the shape of the triangular area, and a vertex pixel information updating step of updating the pixel information of the vertexes and the hypotenuse midpoint of the triangular area.

The image processing method of Aspect 7 is an image processing method of transforming an image to be processed into one square area, dividing the square area into triangular areas, and coding the divided triangular areas. The image processing method includes: an image input step of inputting and storing an image; an image area square-forming step of transforming the input image into one square area; a recurrent triangular-area dividing step of recurrently dividing the square-formed area into triangular areas; a coded data generation step of coding the divided triangular areas; and a coded data output step of outputting the generated coded data.

In the image processing method of Aspect 8, in Aspect 7, the number of pixels contained in one side of the square area generated in the image area square-forming step is preferably 2 raised to the N-th power+1 (where N is a natural number).

In the image processing method of Aspect 9, in Aspect 7 or 8, the recurrent triangular-area dividing step includes a shape type storing step of storing the type of the shape of a triangular area, a vertex pixel information storing step of storing the pixel information of the vertexes and the hypotenuse midpoint of the triangular area, a hypotenuse midpoint pixel information obtaining step of obtaining the pixel information of the hypotenuse midpoint of the triangular area, a shape type updating step of updating the type of the shape of the triangular area, and a vertex pixel information updating step of updating the pixel information of the vertexes and the hypotenuse midpoint of the triangular area.

The image processing method of Aspect 10 is an image processing method of recurrently dividing an image which is transformed into one square area into triangular areas and decoding the coded data obtained by coding the divided triangular areas. The image processing method includes: a coded data input step of inputting coded data; a coded data analysis step of analyzing the input coded data; a recurrent triangular-area combining step of recurrently combining triangular areas on the basis of the analyzed coded data; a square-area combining step of combining a square area on the basis of the combined triangular areas; and an image data output step of transforming the combined square area into the original image data area.

In the image processing method of Aspect 11, in Aspect 10, the number of pixels contained in one side of the square area generated in the square-area combining step is preferably 2 raised to the N-th power+1 (where N is a natural number).

In the image processing method of Aspect 12, in Aspect 10 or 11, the recurrent triangular-area combining step includes a shape type storing step of storing the type of the shape of a triangular area, a vertex pixel information storing step of storing the pixel information of the vertexes and the hypotenuse midpoint of the triangular area, a hypotenuse midpoint pixel information obtaining step of obtaining the pixel information of the hypotenuse midpoint of the triangular area, a shape type updating step of updating the type of the shape of the triangular area, and a vertex pixel information updating step of updating the pixel information of the vertexes and the hypotenuse midpoint of the triangular area.

In the image processing device of the present invention, the invention of Aspect 13 to Aspect 15 is an invention related to processing to divide an image to be processed into one or more square areas in order to generate a plurality of square areas and for coding each square area, and the invention of Aspect 16 to Aspect 18 is an invention related to decoding therefor. Furthermore, the invention of Aspect 19 to Aspect 21 is an invention related to processing to generate one square area by transforming an image to be processed into a square and to code the square area, and the invention of Aspect 22 to Aspect 24 is an invention related to decoding therefor.

The image processing device of Aspect 13 is an image processing device to divide an image to be processed into one or more square areas, to divide each square area into triangular areas, and to code the divided triangular areas. The image processing device includes: an image input device to input and store an image; a square-area dividing device to divide the input image into one or more square areas; a recurrent triangular-area dividing device to recurrently divide each divided square area into triangular areas; a coded data generation device to code the divided triangular areas; and a coded data output device to output the generated coded data.

In the image processing device of Aspect 14, in Aspect 13, the number of pixels contained in one side of the square area generated by the square-area dividing device is preferably 2 raised to the N-th power+1 (where N is a natural number).

In the image processing device of Aspect 15, in Aspect 13 or 14, the recurrent triangular-area dividing device includes a shape type storage device to store the type of the shape of a triangular area, a vertex pixel information storage device to store the pixel information of the vertexes and the hypotenuse midpoint of the triangular area, a hypotenuse midpoint pixel information obtaining device to obtain the pixel information of the hypotenuse midpoint of the triangular area, a shape type updating device to update the type of the shape of the triangular area, and a vertex pixel information updating device to update the pixel information of the vertexes and the hypotenuse midpoint of the triangular area.

The image processing device of Aspect 16 is an image processing device to recurrently divide each square area of an image which is divided into one or more square areas into triangular areas and to decode the coded data obtained by coding the divided triangular areas. The image processing device includes: a coded data input device to input the coded image data; a coded data analysis device to analyze the input coded data; a recurrent triangular-area combining device to recurrently combine triangular areas on the basis of the analyzed coded data; a square-area combining device to combine a square area on the basis of the combined triangular areas; and an image data output device to reconstruct the image data from the combined square area and output the image data.

In the image processing device of Aspect 17, in Aspect 16, the number of pixels contained in one side of the square area generated by the square-area combining device is preferably 2 raised to the N-th power+1 (where N is a natural number).

In the image processing device of Aspect 18, in Aspect 16 or 17, the recurrent triangular-area combining device includes shape type storage device to store the type of the shape of a triangular area, a vertex pixel information storage device to store the pixel information of the vertexes and the hypotenuse midpoint of the triangular area, a hypotenuse midpoint pixel information obtaining device to obtain the pixel information of the hypotenuse midpoint of the triangular area, a shape type updating device to update the type of the shape of the triangular area, and a vertex pixel information updating device to update the pixel information of the vertexes and the hypotenuse midpoint of the triangular area.

The image processing device of Aspect 19 is an image processing device to transform an image to be processed into one square area, to divide the square area into triangular areas, and to code the divided triangular areas. The image processing device includes: an image input device to input and store an image; an image area square-forming device to transform the input image into one square area; a recurrent triangular-area dividing device to recurrently divide the square-formed area into triangular areas; a coded data generation device to code the divided triangular areas; and a coded data output device to output the generated coded data.

In the image processing device of Aspect 20, in Aspect 19, the number of pixels contained in one side of the square area generated by the image area square-forming device is preferably 2 raised to the N-th power+1 (where N is a natural number).

In the image processing device of Aspect 21, in Aspect 19 or 20, the recurrent triangular-area dividing device includes a shape type storage device to store the type of the shape of a triangular area, a vertex pixel information storage device to store the pixel information of the vertexes and the hypotenuse midpoint of the triangular area, a hypotenuse midpoint pixel information obtaining device to obtain the pixel information of the hypotenuse midpoint of the triangular area, a shape type updating device to update the type of the shape of the triangular area, and a vertex pixel information updating device to update the pixel information of the vertexes and the hypotenuse midpoint of the triangular area.

The image processing device of Aspect 22 is an image processing device to recurrently divide an image which is transformed into one square area into triangular areas and to decode the coded data obtained by coding the divided triangular areas. The image processing device includes: a coded data input device to input coded data; a coded data analysis device to analyze the input coded data; a recurrent triangular-area combining device to recurrently combine triangular areas on the basis of the analyzed coded data; a square-area combining device to combine a square area on the basis of the combined triangular areas; and an image data output device to transform the combined square area into the original image data area.

In the image processing device of Aspect 23, in Aspect 22, the number of pixels contained in one side of the square area generated by the square-area combining device is preferably 2 raised to the N-th power+1 (where N is a natural number).

In the image processing device of Aspect 24, in Aspect 22 or 23, the recurrent triangular-area combining device includes a shape type storage device to store the type of the shape of a triangular area, a vertex pixel information storage device to store the pixel information of the vertexes and the hypotenuse midpoint of the triangular area, a hypotenuse midpoint pixel information obtaining device to obtain the pixel information of the hypotenuse midpoint of the triangular area, a shape type updating device to update the type of the shape of the triangular area, and a vertex pixel information updating device to update the pixel information of the vertexes and the hypotenuse midpoint of the triangular area.

In the image processing program of the present invention, the invention of Aspect 25 to Aspect 27 is an invention related to processing to divide an image to be processed into one or more square areas in order to generate a plurality of square areas and to code each square area, and the invention of Aspect 28 to Aspect 30 is an invention related to decoding therefor.

Furthermore, the invention of Aspect 31 to Aspect 33 is an invention for processing to generate one square area by transforming an image to be processed into a square and to code each square area, and the invention of Aspect 34 to Aspect 36 is an invention related to decoding therefor.

More specifically, the image processing program of Aspect 25 is an image processing program for dividing an image to be processed into one or more square areas, dividing each square area into triangular areas, and coding the divided triangular areas. The image processing program includes: an image input program for inputting the image to be processed and storing the image; a square-area dividing program for dividing the input image into one or more square areas; a recurrent triangular-area dividing program for recurrently dividing each divided square area into triangular areas; a coded data generation program for coding the divided triangular areas; and a coded data output program for outputting the generated coded data.

In the image processing program of Aspect 26, in Aspect 25, the number of pixels contained in one side of the square area generated in the square-area dividing program is preferably 2 raised to the N-th power+1 (where N is a natural number).

In the image processing program of Aspect 27, in Aspect 25 or 26, the recurrent triangular-area dividing program includes a shape type storing program for storing the type of the shape of a triangular area, a vertex pixel information storing program for storing the pixel information of the vertexes and the hypotenuse midpoint of the triangular area, a hypotenuse midpoint pixel information obtaining program for obtaining the pixel information of the hypotenuse midpoint of the triangular area, a shape type updating program for updating the type of the shape of the triangular area, and a vertex pixel information updating program for updating the pixel information of the vertexes and the hypotenuse midpoint of the triangular area.

The image processing program of Aspect 28 is an image processing method of recurrently dividing each square area of an image which is divided into one or more square areas into triangular areas and decoding the coded data obtained by coding the divided triangular areas. The image processing program includes: a coded data input program for inputting the coded image data; a coded data analysis program for analyzing the input coded data; a recurrent triangular-area combining program for recurrently combining triangular areas on the basis of the analyzed coded data; a square-area combining program for combining a square area on the basis of the combined triangular areas; and an image data output program for reconstructing the image data from the combined square area and outputting the image data.

In the image processing program of Aspect 29, in Aspect 28, the number of pixels contained in one side of the square area generated in the square-area combining step is preferably 2 raised to the N-th power+1 (where N is a natural number).

In the image processing program of Aspect 30, in Aspect 28 or 29, the recurrent triangular-area combining program includes a shape type storing program for storing the type of the shape of a triangular area, a vertex pixel information storing program for storing the pixel information of the vertexes and the hypotenuse midpoint of the triangular area, a hypotenuse midpoint pixel information obtaining program for obtaining the pixel information of the hypotenuse midpoint of the triangular area, a shape type updating program for updating the type of the shape of the triangular area, and a vertex pixel information updating program for updating the pixel information of the vertexes and the hypotenuse midpoint of the triangular area.

The image processing program of Aspect 31 is an image processing method of transforming an image to be processed into one square area, dividing the square area into triangular areas, and coding the divided triangular areas. The image processing program includes: an image input program for inputting and storing an image; an image area square-forming program for transforming the input image into one square area; a recurrent triangular-area dividing program for recurrently dividing the square-formed area into triangular areas; a coded data generation program for coding the divided triangular areas; and a coded data output program for outputting the generated coded data.

In the image processing program of Aspect 32, in Aspect 31, the number of pixels contained in one side of the square area generated in the image area square-forming program is preferably 2 raised to the N-th power+1 (where N is a natural number).

In the image processing program Aspect 33, in Aspect 31 or 32, the recurrent triangular-area dividing program includes a shape type storing program for storing the type of the shape of a triangular area, a vertex pixel information storing program for storing the pixel information of the vertexes and the hypotenuse midpoint of the triangular area, a hypotenuse midpoint pixel information obtaining program for obtaining the pixel information of the hypotenuse midpoint of the triangular area, a shape type updating program for updating the type of the shape of the triangular area, and a vertex pixel information updating program for updating the pixel information of the vertexes and the hypotenuse midpoint of the triangular area.

The image processing program of Aspect 34 is an image processing method of recurrently dividing an image which is transformed into one square area into triangular areas and decoding the coded data obtained by coding the divided triangular areas. The image processing program includes: a coded data input program for inputting coded data; a coded data analysis program for analyzing the input coded data; a recurrent triangular-area combining program for recurrently combining triangular areas on the basis of the analyzed coded data; a square-area combining program for combining a square area on the basis of the combined triangular areas; and an image data output program for transforming the combined square area into the original image data area.

In the image processing program of Aspect 35, in Aspect 34, the number of pixels contained in one side of the square area generated in the square-area combining program is preferably 2 raised to the N-th power+1 (where N is a natural number).

In the image processing program of Aspect 36, in Aspect 34 or 35, the recurrent triangular-area combining step includes a shape type storing program for storing the type of the shape of a triangular area, a vertex pixel information storing program for storing the pixel information of the vertexes and the hypotenuse midpoint of the triangular area, a hypotenuse midpoint pixel information obtaining program for obtaining the pixel information of the hypotenuse midpoint of the triangular area, a shape type updating program for updating the type of the shape of the triangular area, and a vertex pixel information updating program for updating the pixel information of the vertexes and the hypotenuse midpoint of the triangular area.

In the manner described above, the present invention performs processing after an image is formed into a square area. According to the invention of Aspect 1 to Aspect 3, the invention of Aspect 13 to Aspect 15, and the invention of Aspect 25 to Aspect 27, when image data to be processed is to be coded, the image data to be processed is divided into one or more square areas, the extracted square is recurrently divided into triangular areas, and the pixel information of the three vertexes of each of the obtained triangular areas (hereinafter referred to as the “pixel values”) and the pixel value of the midpoint of the hypotenuse are obtained. At this time, the type of each triangle obtained by the recurrent dividing process can be automatically determined according to a division sequence as long as the manner of dividing the original square is determined in advance. Furthermore, for the pixel values of the vertexes of each triangle, the pixel values possessed by the square can be succeeded as they are, and the pixel value of the midpoint of the hypotenuse can be determined from the original square.

Then, the type of triangle and the pixel values to be stored by such a recurrent triangle dividing process can be represented by a binary tree, and these can be output as one-dimensionalized data on the basis of the binary tree.

According to the above, for coding image data to be processed, a less amount of data to be stored or transmitted is required when coding is performed. This makes it possible to greatly simplify computations and to greatly reduce the amount of memory used.

Also, for decoding data which is coded in this manner (corresponding to the invention of Aspect 4 to Aspect 6, the invention of Aspect 16 to Aspect 18, and the invention of Aspect 28 to Aspect 30), a less amount of data to be stored, which is necessary to provide decoding, is required in a manner similar to coding. This makes it possible to greatly simplify computations and to greatly reduce the amount of memory used. Furthermore, by setting the priority in the order of transmission or reading of data represented by a binary tree on the basis of a region of interest of the image, only a specific portion within the entire image can be displayed with a high resolution more quickly. As a result, in a case where desired image data is to be searched for from among a lot of image data or image data is to be classified, only the feature portions of individual images can be displayed with a high resolution more quickly, making it possible to efficiently perform searching and classification of images.

Furthermore, according to the invention of Aspect 7 to Aspect 9, the invention of Aspect 19 to Aspect 21, and the invention of Aspect 31 to Aspect 33, for coding image data to be processed, one square area is generated by transforming image data to be processed into a square, the one square is recurrently divided into triangular areas, and the pixel values of the three vertexes of each of the obtained triangular areas and the pixel value of the midpoint of the hypotenuse thereof are coded.

In the manner described above, since one square area is generated by transforming image data to be processed into a square and the one square area is recurrently divided into triangular areas, only one binary tree representation needs to be generated in such a manner as to correspond to one square area, it is possible to require a further reduced amount of data to be stored to provide coding, thereby making it possible to greatly simplify computations and to greatly reduce the amount of memory used.

The same applies to a case in which the image data is decoded (corresponding to the invention of Aspect 10 to Aspect 12, the invention of Aspect 22 to Aspect 24, and the invention of Aspect 34 to Aspect 36). it is possible to further reduce the amount of data to be stored to provide decoding, thereby making it possible to greatly simplify computations and to greatly reduce the amount of memory used.

In the invention of the foregoing, with respect to a square area to be generated, preferably, a condition such that the number of pixels contained in one side of the square area becomes 2 raised to the N-th power+1 (where N is a natural number). As a result, a pixel always exists at the midpoint of the hypotenuse of the divided triangles, and the recurrent triangle dividing process can be made easier.

### BRIEF DESCRIPTION OF THE DRAWINGS

FIG. 1 is a schematic that illustrates a first exemplary embodiment of the present invention, on the coding side of an image processing device;

FIG. 2 is a schematic that illustrates the configuration of image data input device shown in FIG. 1;

FIGS. 3(a) and 3(b) are schematics that show an example in which, when an image used in the first exemplary embodiment is a square, the image is divided into triangles;

FIGS. 4(a) and 4(b) are schematics that show an example in which, when an image used in the first exemplary embodiment is not a square, the image is divided into a plurality of square areas;

FIG. 5 is a flowchart illustrating a dividing process procedure when an image is divided into a plurality of square areas;

FIG. 6 is a schematic that illustrates an example in which a pixel value 0 is supplemented into blank portions which occur when an image is divided into a plurality of square areas;

FIGS. 7(a) and 7(b) are schematics that illustrate two methods (a first method and a second method) of dividing one particular square into two triangles;

FIG. 8 is a schematic that shows eight types of triangles, which are obtained in such a manner that one particular square is divided into two portions in order to obtain two triangles and the two triangles are further recurrently divided;

FIG. 9 is a schematic that illustrates that types of triangles shown in FIG. 8 are correlated with one another;

FIG. 10 is a chart that shows a succeeding rule for the pixel values of the triangles which are divided by the two methods shown in FIG. 7 and the original square;

FIG. 11 is a chart that shows a succeeding rule for the types of triangles which are obtained by dividing each of the eight types shown in FIG. 8 into two portions, and the pixel values thereof;

FIG. 12 is a schematic that shows types of triangles, which are obtained in such a manner that two triangles which are obtained by dividing one particular square by the first method are further divided into two portions;

FIG. 13 is a schematic that represents, by using a binary tree, types of triangles, which are obtained in such a manner that two triangles obtained by dividing one particular square into two portions by the first method are further divided into two portions and these are further divided into two portions;

FIG. 14 is a schematic in which the number of pixels of one side is 3 and specific numerical values (pixel values) are given to the respective pixels in order to specifically illustrate the first exemplary embodiment;

FIGS. 15A-15C are schematics that illustrate an example in which a recurrent dividing process of a triangular area is performed with reference to FIG. 14;

FIG. 16 is a flowchart illustrating the recurrent dividing process procedure of a triangular area, shown in FIG. 15;

FIG. 17 is a schematic that illustrates processing of obtaining pixel values to be determined when the recurrent dividing processing procedure of a triangular area, shown in FIG. 15, is performed by referring to the succession rule shown in FIG. 11;

FIG. 18 is a schematic that represents processing shown in FIGS. 15 to 17 by using a binary tree, and is also a diagram in which the pixel value of the midpoint of the hypotenuse is added to the binary tree representation of FIG. 13;

FIG. 19 is a schematic that shows an example in which an example of an image used in the first exemplary embodiment is divided into a plurality of square areas;

FIG. 20 is a schematic that illustrates an example in which each square area obtained in FIG. 19 is represented by a binary tree;

FIG. 21 is a schematic that illustrates an example of a procedure of coding image data represented by one particular binary tree;

FIG. 22 is a schematic that shows an example of data which is coded by the coding procedure described with reference to FIG. 21;

FIG. 23 is a schematic that illustrates another example of a procedure of coding image data represented by one particular binary tree;

FIG. 24 is a schematic that shows an example of data which is coded by the coding procedure described with reference to FIG. 23;

FIG. 25 is a flowchart illustrating the overall processing procedure of the first exemplary embodiment;

FIG. 26 is a schematic that illustrates a second exemplary embodiment of the present invention of the decoding side of an image processing device;

FIGS. 27A-27C are schematics that illustrate a procedure of decoding the coded data of FIG. 22;

FIGS. 28A-28D are schematics that illustrate the decoding procedure of FIGS. 27A-27C by using the reconstruction of an actual image as an example;

FIG. 29 is a schematic that illustrates an example of processing of interpolating data into the interior of a triangle when image data is to be decoded;

FIG. 30 is a schematic that illustrates processing of combining specific regions (for example, regions of interest) with a high resolution with priority when image data is to be decoded;

FIG. 31 is a schematic that shows an example in which a specific region in FIG. 30 corresponds to an image to be processed;

FIGS. 32A-32C are schematics that show the change of the degree of reconstruction of an image which is reconstructed by the decoding procedure in FIG. 30;

FIG. 33 is a flowchart illustrating the overall processing procedure of the second exemplary embodiment;

FIG. 34 is a schematic that illustrates the configuration of image data output device shown in FIG. 26;

FIG. 35 is a schematic that illustrates a third exemplary embodiment of the present invention on the coding side of an image processing device;

FIG. 36 is a flowchart illustrating the overall processing procedure of the third exemplary embodiment;

FIG. 37 is a schematic that illustrates a fourth exemplary embodiment of the present invention on the decoding side of an image processing device;

FIG. 38 is a flowchart illustrating the overall processing procedure of the fourth exemplary embodiment.

### DETAILED DESCRIPTION OF PREFERRED EMBODIMENTS

Exemplary embodiments of the present invention are described below with reference to the drawings.

### First Exemplary Embodiment

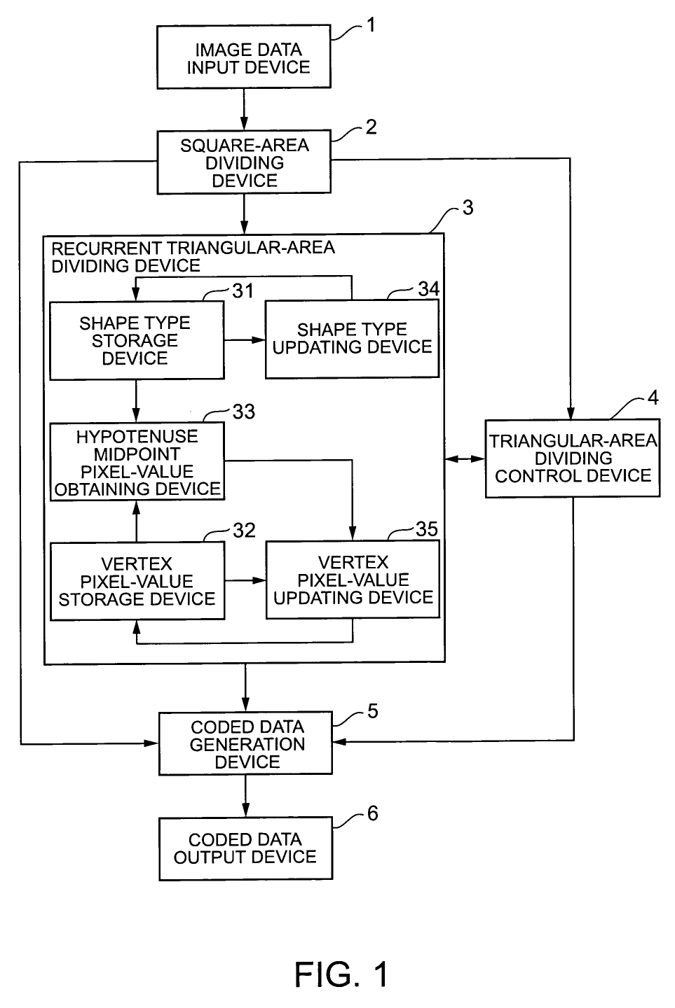

FIG. 1 illustrates a first exemplary embodiment of an image processing device according to the present invention, and shows the configuration on the coding side. When the configuration is broadly classified, the image processing device includes an image data input device 1, a square-area dividing device 2, a recurrent triangular-area dividing device 3, a triangular-area dividing control device 4, a coded data generation device 5, and a coded data output device 6.

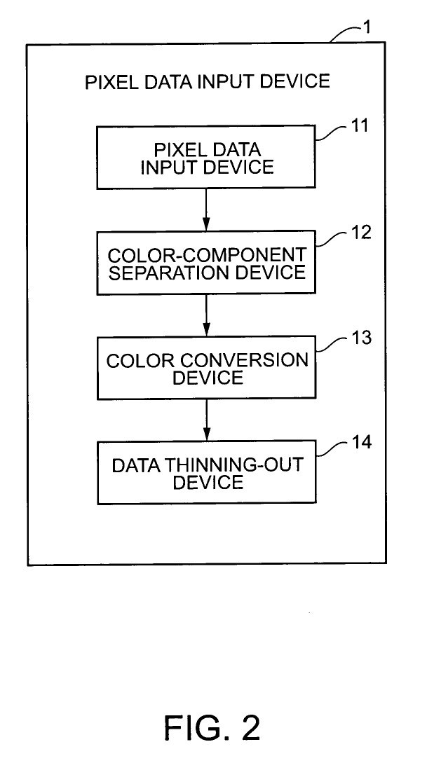

As shown in FIG. 2, the image data input device 1 includes a pixel data input device 11 to input individual pixel data; a color-component separation device 12 to separate the input color data of the pixels into respective components; a color conversion device 13 to perform a conversion from, for example, RGB into YUV data on the basis of the separated color data; and a data thinning-out device 14 to thin out data if necessary. Examples of image data input to the image data input device 1 include image data from a camera, image data from a file, and image data from some kind of communication device.

The recurrent triangular-area dividing device 3 includes at least a shape type storage device 31 to store a plurality of types of triangle types (this is described below), a vertex pixel-value storage device 32 to store the pixel values of the three vertexes of a triangle and the pixel value of the midpoint of the hypotenuse thereof, a hypotenuse midpoint pixel-value obtaining device 33 to supplement the pixel value of the midpoint of the hypotenuse of the triangle, a shape type updating device 34 to update the triangle type by using a rule (described below) (see FIG. 11), and a vertex pixel-value updating device 35 to update the pixel values of the three vertexes of a triangle and the pixel value of the midpoint of the hypotenuse thereof.

The operation of each component element shown in FIG. 1 is described below in detail.

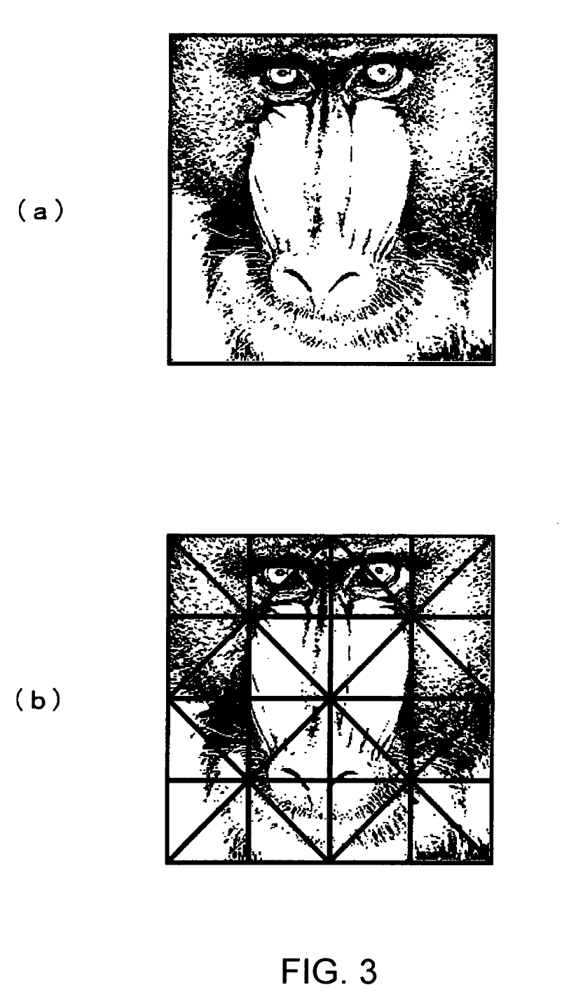

In the present invention, image data to be processed is formed into a square, the image data is recurrently divided into triangular areas, and image processing is performed on those triangular areas. For example, it is assumed that one particular color component of the image data obtained from the image data input device 1 is as shown in FIG. 3(a). In the present invention, this is represented as a set of triangular areas as shown in FIG. 3(b).

In this manner, in the present invention, processing is performed on the presumption that the image data to be processed is a square. However, the image data obtained from the image data input device 1 is not always a square. Accordingly, a description is given below of processing in a case where image data is not a square.

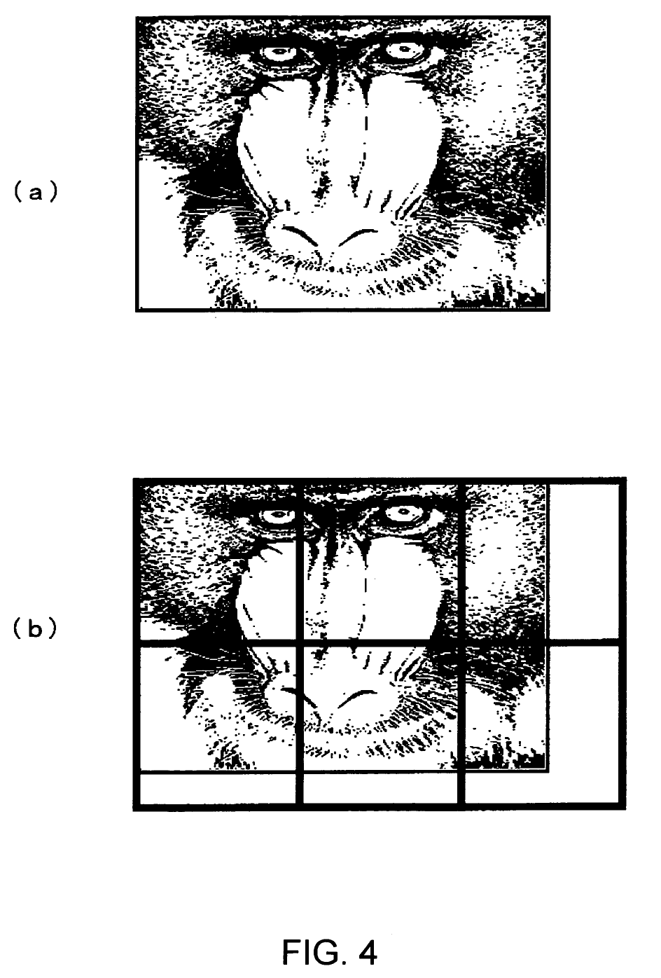

When the input image data is not a square, the input image data is divided into one or more square areas by the square-area dividing device 2. For example, when the input image data is a rectangular image in landscape as shown in FIG. 4(a), this is divided into a plurality of square areas as shown in FIG. 4(b). At this time, when the number of pixels contained in one side of the square to be divided is denoted as L, L is preferably 2 raised to the N-th power+1. The reason for this is described below. N is a natural number.

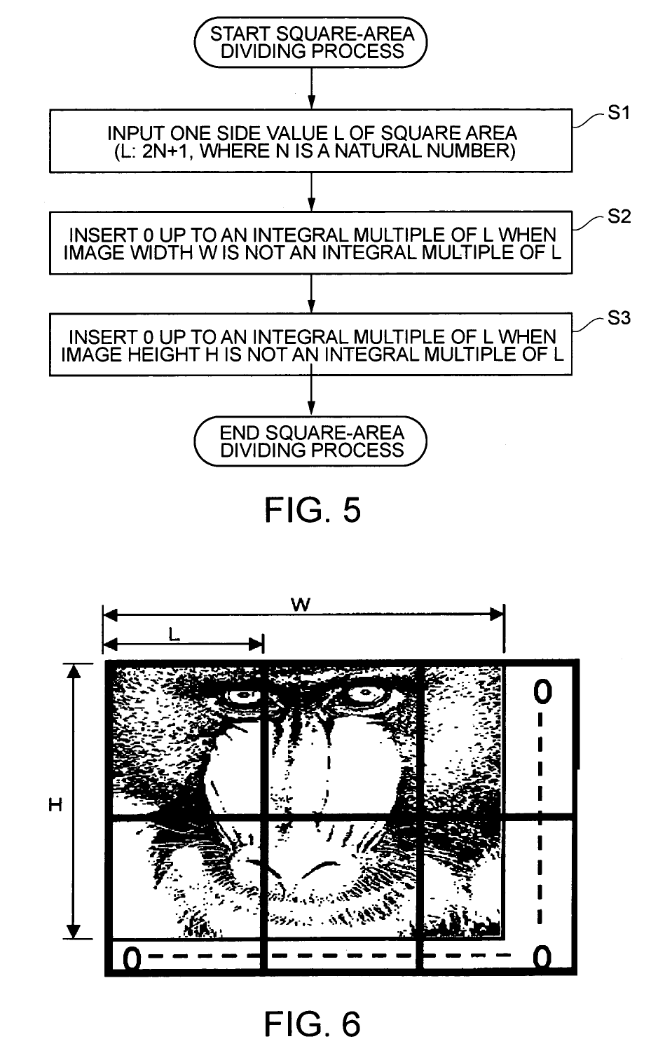

In this manner, when an image which is not originally a square is divided into square areas by the square-area dividing device 2, as shown in FIG. 4(b), blank portions in which an image does not exist occur in square portions overlapping the end portions of the image. In general, the width and the height of the image data are not an integral multiple of L. Processing for these blank portions and processing in a case where the width and the height of the image data are not an integral multiple of L is described with reference to the flowchart in FIG. 5 and an example of an image of FIG. 6.

FIG. 5 is a flowchart illustrating a square-area dividing process procedure performed by the square-area dividing processing device 2. Initially, L is input as one side value of a square area to be divided (step S1), where, as described above, L is 2 raised to the N-th power+1 (where N is a natural number). When the width W of the subject image is not an integral multiple of L, 0 is inserted until the width of the subject image becomes an integral multiple of L (step S2). Similarly, when the height H of the subject image is not an integral multiple of L, 0 is inserted until the height H of the subject image becomes an integral multiple of L (step S3).

FIG. 6 shows an example in which a square-area dividing process described with reference to FIG. 5 is performed on a certain rectangular image. As can also be seen from FIG. 6, since the width W of the subject image is not an integral multiple of L, assuming that the width of the subject image is an integral multiple of L, 0 is filled in the blank portions. Similarly, since the height H of the subject image is not an integral multiple of L, assuming that the height H of the subject image is an integral multiple of L, 0 is filled in the blank portions.

The example described with reference to FIGS. 5 and 6 is such that, assuming that the width and the height of the image are integral multiples of L, 0 is filled in the blank portions which occur as a result of the above assumption. Alternatively, for example, as can be seen in processing, such as jpeg, in the widthwise direction, the pixel value of the rightmost column in the subject image may be repeated, and in the height direction, the pixel value of the bottommost row in the subject image may be repeated. Furthermore, as can be seen in jpeg 2000, in the widthwise direction, the pixel value may be folded back at the rightmost column in the subject image, and in the height direction, the pixel value may be folded back at the bottommost row in the subject image.

Subsequent processing is independent processing in each of the divided square areas in the same manner as in JPEG. Therefore, the description is continued assuming that image data is a square without deteriorating generalities.

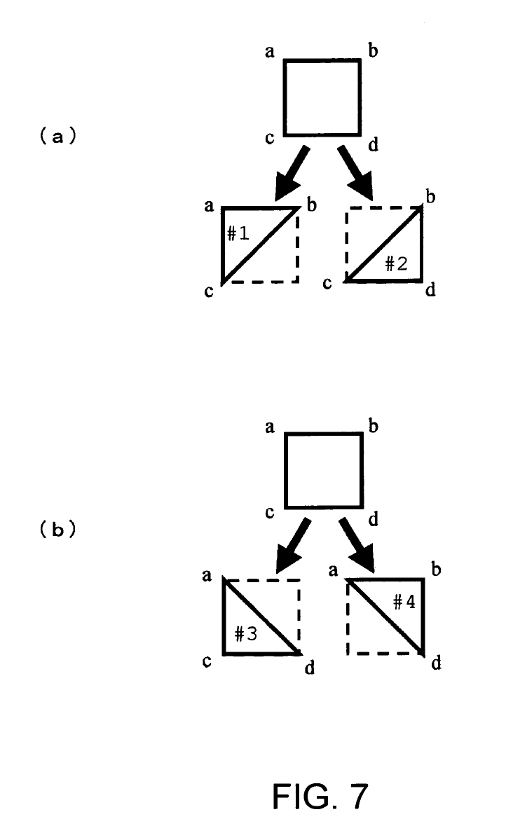

Next, a description is given of processing for dividing each square, which is divided into square areas in the manner described above, into triangles. This processing of dividing into triangles is performed by the recurrent triangular-area dividing device 3. The recurrent triangular-area dividing device 3 recurrently divides each square area into triangular areas; for example, as shown in FIGS. 7(a) and (b), one particular square area is divided into two triangles. Although not shown in FIGS. 7(a) and (b), the divided triangles are each further divided into triangles.

There are two kinds of methods for dividing a square into triangles. A first method is a dividing method such as that shown in FIG. 7(a), and a second method is a dividing method such as that shown in FIG. 7(b).

More specifically, when the pixel values of the four corner portions of a square are denoted as a, b, c, and d, FIG. 7(a) shows an example in which a square is divided into two triangles by the first method, and FIG. 7(b) shows an example in which a square is divided into two triangles by the second method. The types of triangles generated as a result of being divided by using the first and second methods are represented as #1, #2, #3, and #4, as shown in the respective figures.

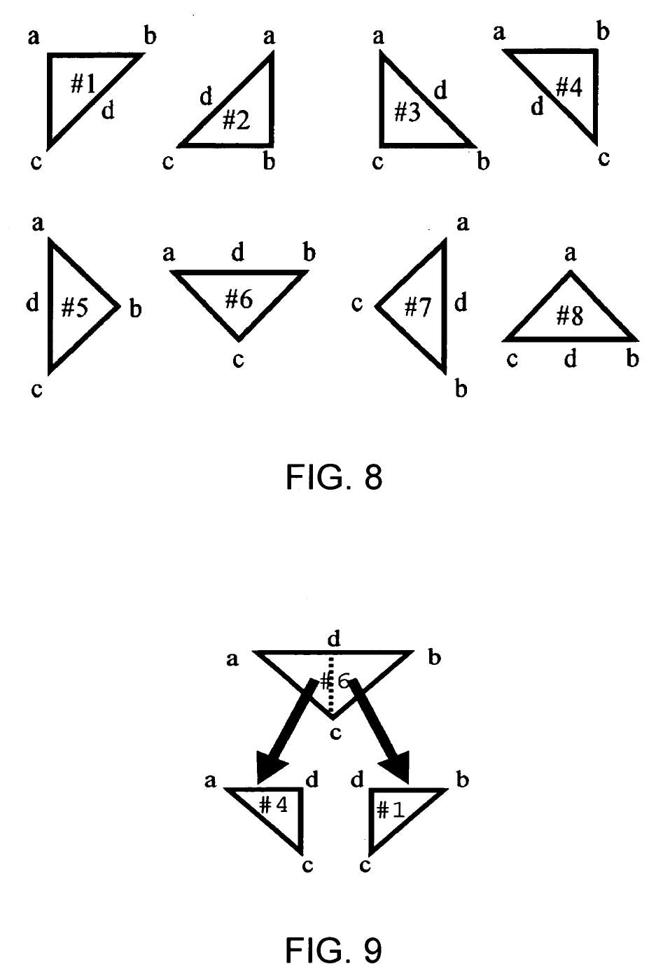

There are a total of eight types for the triangles obtained by recurrently dividing the triangles which are divided as in FIGS. 7(a) and (b), and each of the eight types is assigned with a type number of #1, #2, #3, #4, #5, #6, #7, or #8 as shown in FIG. 8. a, b, and c, which are assigned to the respective vertexes of each triangle shown in FIG. 8, indicate the pixel value at each position. d assigned to each hypotenuse indicates the pixel value at the position of the midpoint of the hypotenuse, and this is described below.

The types of the respective triangles (triangle types) on which such recurrent triangular-area division is performed can be correlated with one another. For example, as shown in FIG. 9, when a triangle of the type of #6 is divided, triangles of the types of #1 and #4 are generated. That is, in the recurrent triangular-area dividing process of the present invention, since the type of the triangle after the dividing process is automatically determined from the type of the original triangle, there is no need to store the type of the triangle in the output data.

The method of dividing a square into triangles with reference to FIGS. 7(a) and 7(b) described above (the first method and the second method) is described above. The manner in which, at that time, the pixel values at the positions of the four vertexes of the square are succeeded to the triangles is described below.

If it is assumed here that the pixel values of the four vertexes of the square are a, b, c, and d, there are two types of patterns for the succeeding patterns of the pixel values a, b, c, and d of the four vertexes of the square depending on the division methods described with reference to FIGS. 7(a) and (b).

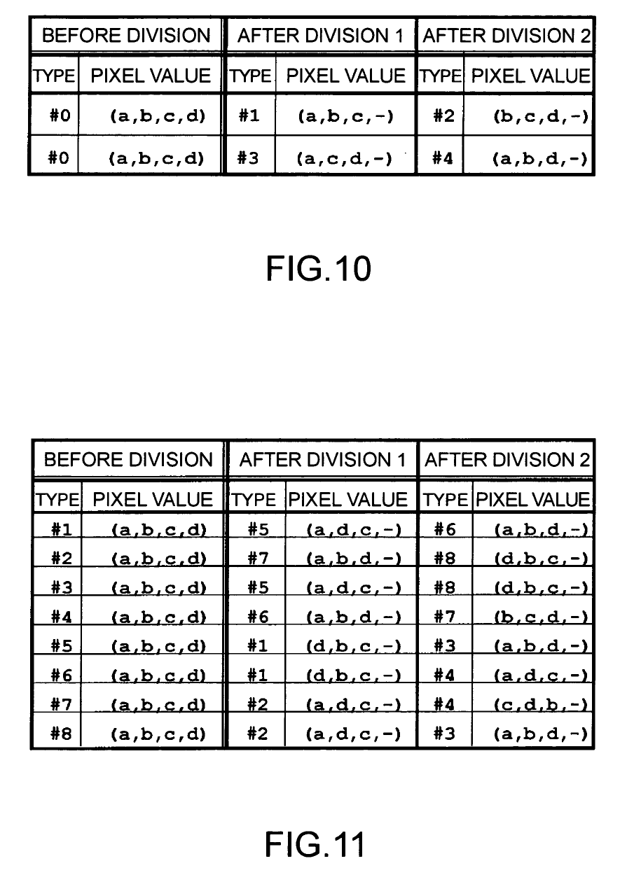

FIG. 10 shows a succeeding rule thereof. For example, if a square is divided into triangles by the method shown in FIG. 7(a) (the first method), and if, as shown in the upper row of FIG. 10, the type before being divided (square) is denoted as #0 here, for the pixel values (a, b, c, d) of the four vertexes of the square, (a, b, c, −) is succeeded as the pixel values of the triangle of the #1 type, and (b, c, d, −) is succeeded as the pixel values of the triangle of the #2 type.

On the other hand, if the square is divided into triangles by the method shown in FIG. 7(b) (the second method), and if, as shown in the lower row of FIG. 10, the type before being divided (square) is also denoted as #0 here, for the pixel values (a, b, c, d) of the four vertexes of the square, (a, c, d, −) is succeeded as the pixel values of the triangle of the #3 type, which is obtained in the triangle division, and (a, b, d, −) is succeeded as the pixel values of the triangle of the #4 type.

In the present invention, the four pixel values such that, in addition to the pixel values of the three vertexes of each triangle, the pixel information of the midpoint of the hypotenuse of the triangle is added, are taken into consideration. In FIG. 10, the portion indicated by a hyphen “-” is the pixel value of the midpoint of the hypotenuse, and this hyphen indicates that the pixel value is unknown or that the pixel value needs to be set.

FIG. 11 shows the succession rule of pixel values when eight types of triangles shown in FIG. 8 are further divided. As shown in FIG. 11, when the triangle, which is a certain type (#1 to #8) before being divided, is divided, each becomes two types of triangles, and the pixel values at that time are succeeded as shown in FIG. 11. In FIG. 11, also, the portion indicated by a hyphen “-” is the pixel value of the midpoint of the hypotenuse, and this hyphen indicates that the pixel value is unknown or that the pixel value needs to be set.

According to FIG. 11, for example, when a triangle of #6 type, whose pixel values of the vertexes are a, b, and c and whose pixel value of the midpoint of the hypotenuse is d, is divided, the triangle is divided into two triangles of #1 type and #4 type (see FIG. 9), and the pixel values of the triangle of #1 type becomes (a, d, c, −), and the pixel values of the triangle of #4 type becomes (c, d, b, −).

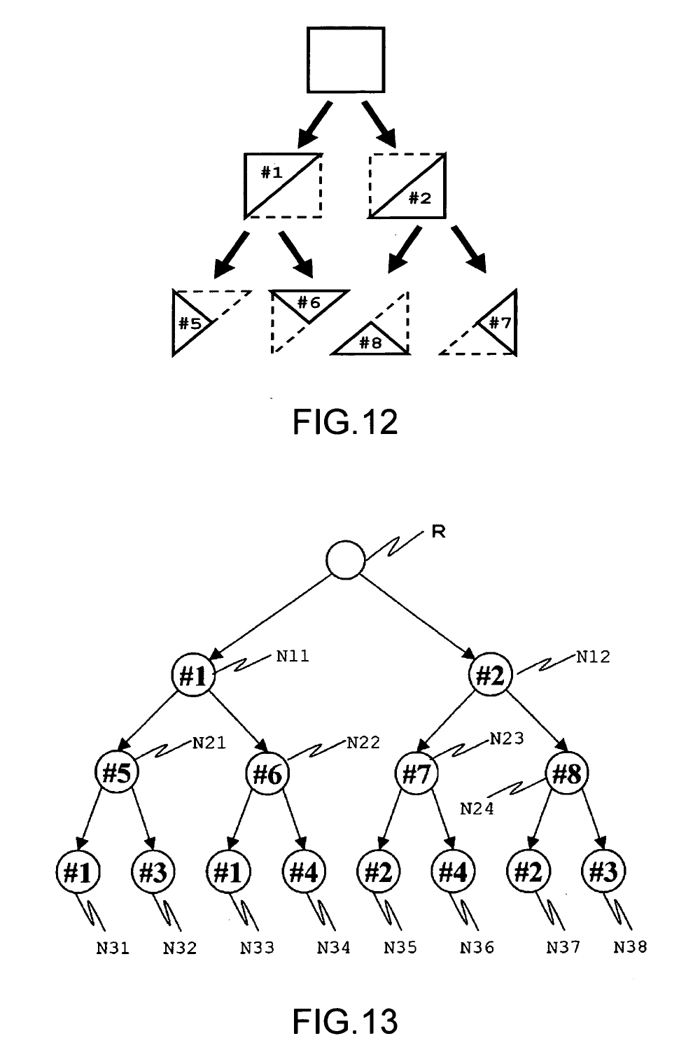

The summary of the above recurrent triangle dividing process is described below with reference to FIG. 12. It is assumed that one particular square is divided into triangles of the types of #1 and #2. These triangles of the types of #1 and #2 are further divided into triangles of the types of #5 and #6 with regard to #1 type and into triangles of the types of #7 and #8 with regard to #2 type. These divided triangles are further divided into smaller triangles. In this recurrent dividing process, division is possible one after another as long as a pixel exists in the midpoint of the hypotenuse, but the dividing process can be terminated at a predetermined stage even if the division limitation is not reached. To which stage the division is performed can be set in advance.

The above-described recurrent triangle dividing process can be represented using a binary tree shown in FIG. 13. In FIG. 13, the numeral within ∘ indicates the type of triangle. ∘ with no numeral inside in the topmost portion is assumed to be a square, and a binary tree in which this is a root R is generated.

The triangle types of two nodes N11 and N12 generated from the root R correspond to the two division methods (the first method and the second method) of FIGS. 7(a) and 7(b). If this triangle type is determined, the triangles which are formed by dividing each node into two portions are uniquely determined by the succession rule shown in FIG. 11. For example, the triangle having #1 type is divided into two triangles of #5 and #6 types, as can be seen from FIG. 11.

Similarly, the triangle having #5 type is divided into two triangles of #1 and #3 types, as can be seen from FIG. 11.

Hereafter, for the sake of simplicity of descriptions, the triangle whose triangle type is T, whose pixel values of the three vertexes are a, b, and c, and whose pixel value of the midpoint of the hypotenuse is d, is represented as T(a, b, c, d). For example, the triangle whose triangle type is #6, whose pixel values of the three vertexes are a, b, and c, and whose pixel value of the midpoint of the hypotenuse is d, is represented as #6(a, b, c, d), and is also represented such that it is divided into #1(d, b, c, −) and #4(a, d, c, −).

As is clear from this example, in the triangles after each triangle is divided, by supplementing the pixel value of the midpoint of the hypotenuse, which is indeterminate, indicated by the hyphen, the triangular-area division can be recurrently performed by using the succession rule of FIG. 11.

When compared to the technology which requires a total of nine pieces of pixel information of 3 X coordinate values of the three vertexes, 3 Y coordinate values thereof, and 3 pixel values of the three vertexes, and which needs to store the pixel information in order to represent one triangle as in the technology described in Japanese Unexamined Patent Application Publication No. 9-191409, which is recited in the above-described Description of the Related Art section, this has an amount of data of 1/9 in the worst case.

As a result, the recurrent triangular-area dividing device 3 shown in FIG. 1 is able to recurrently divide a triangular area by using at least the shape type storage device 31 to store eight types of triangle types of type 1 to type 8; the vertex pixel-value storage device 32 to store the pixel values of the three vertexes of a triangle and the pixel value of the midpoint of the hypotenuse thereof; the hypotenuse midpoint pixel-value obtaining device 33 to supplement the pixel value of the midpoint of the hypotenuse of a triangle; the shape type updating device 34 to update the triangle type by using the succession rule shown in FIG. 11; and the vertex pixel-value updating device 35 to update the pixel values of the three vertexes of a triangle and the pixel value of the midpoint of the hypotenuse thereof.

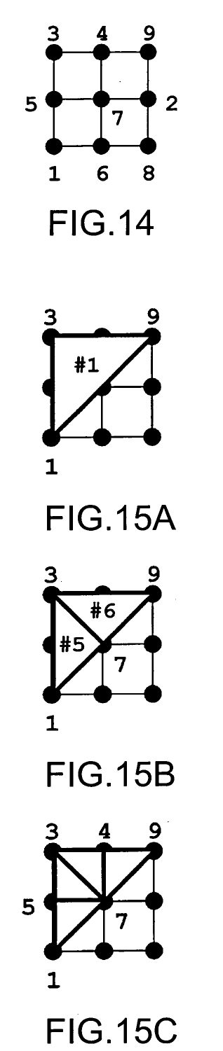

The above recurrent triangular-area dividing process is described below by using an example of specific numerals. For the sake of simplicity of descriptions, as shown in FIG. 14, a square whose number of pixels of one side is L=3 (in this case, it is set that N=1 under the condition in which L is 2 raised to the N-th power+1) is used as an example. In FIG. 14, the respective pixels are shown as black circles, and the numeral assigned to each pixel indicates the pixel value at that pixel.

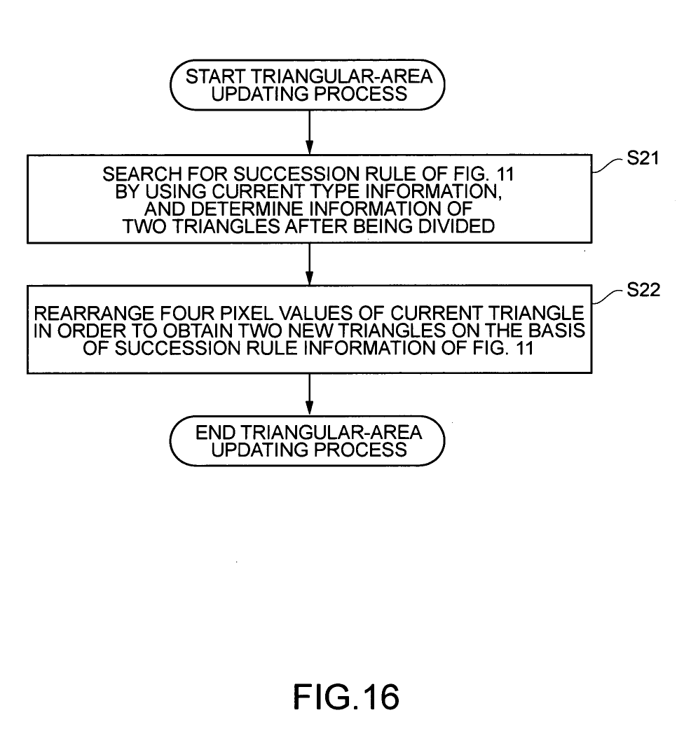

If such a square is divided into two portions by the method shown in FIG. 7(a) (the first method), as shown in FIG. 15A, it is divided into two triangles. Since this triangle at the upper left is a triangle of #1 type and the pixel values of the vertexes thereof is (3, 9, 1), it is represented as #1(3, 9, 1, −), and by supplementing the pixel value 7 of the midpoint of the hypotenuse thereto, information of #1(3, 9, 1, 7) can be generated.

If such information is generated, by using this information, triangles after division are obtained by the procedure shown in the flowchart of FIG. 16. That is, the succession rule shown in FIG. 11 is searched for by using the current type information in order to determine the information of the two triangles after division (step S21). Then, based on the information of the succession rule shown in FIG. 11, the four pixel values of the current triangle are rearranged, and two new triangles are obtained (step S22).

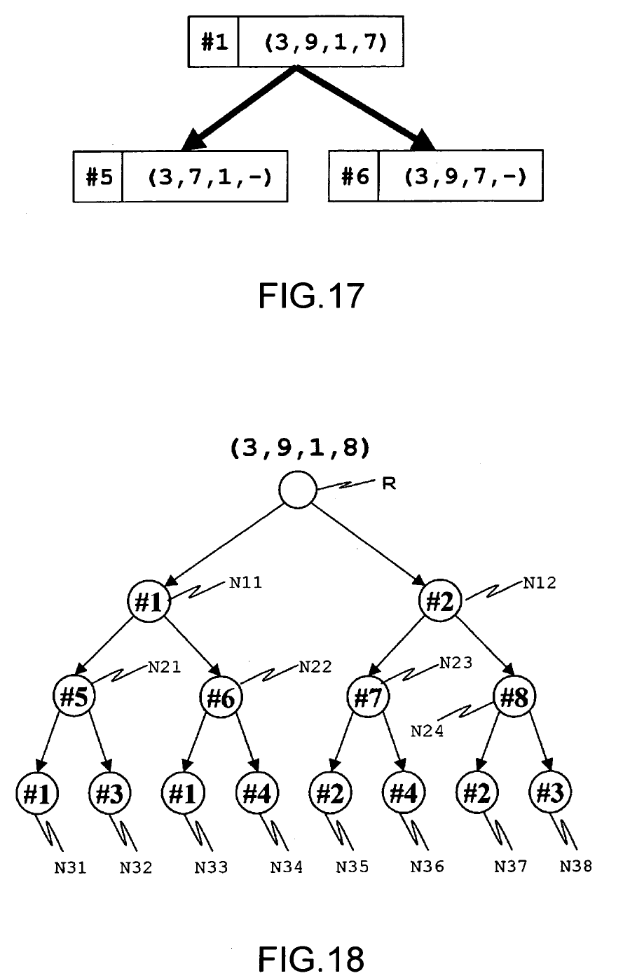

That is, in this example, as shown in FIG. 17, the triangle having the information of #1(3, 9, 1, 7) is divided into #5(3, 7, 1, −) and #6(3, 9, 7, −). These are shown in FIGS. 15A and 15B. When the pixel value of 7 is supplemented to the midpoint of the hypotenuse of the triangle having the information of #1(3, 9, 1, −) and the triangle is divided into two portions, a triangle having the information of #5(3, 7, 1, −) and a triangle having the information of #6(3, 9, 7, −) are obtained. Hereafter, the recurrent triangular-area dividing process is performed by supplementing 5 to the triangle of #5 type and by supplementing 4 to the triangle T12 of #6 type as the pixel value of the midpoint of the hypotenuse of each of these triangles, as shown in FIG. 15C.

The above processing described with reference to FIGS. 14 to 17 can be represented by a binary tree shown in FIG. 18. In this binary tree representation of FIG. 18, similarly to the binary tree representation shown in FIG. 13, since the triangle type shown within ∘ of the binary tree is uniquely determined from the higher-order type, it is not needed to be output as data, and by supplementing only the pixel value of the midpoint of the hypotenuse shown below the ∘, triangular-area division at a lower order can be performed.

FIG. 18 shows a binary tree representation in a case where the square shown in FIG. 14 is divided into triangular areas. As can also be seen from FIG. 14, the pixel values of the four vertexes of the square corresponding to the root R are (3, 9, 1, 8), and a triangular-area dividing process described with reference to FIGS. 15A, 15B, and 15C is performed on such a square.

In this manner, with respect to image data to be processed, an image of a square area can be represented by using three types of data of the pixel values of the four vertexes of the original square, types of triangles such that the original square is divided into triangles at first, and the chain of the pixel values of the midpoints of the hypotenuses of the divided triangles.

Among the above data, when the square is divided into triangles at first, whether it is performed by the first method or the second method of FIGS. 7(a) or 7(b) can be fixed. Furthermore, if the number of pixels L contained in one side of a square area satisfies the condition in which L becomes 2 raised to the N-th power+1 (where N is a natural number), a pixel always exists at the midpoint of the hypotenuse of the divided triangles. For this reason, in order to make processing easier, preferably, the number of pixels L contained in one side of the square area is 2 raised to the N-th power+1 (where N is a natural number).

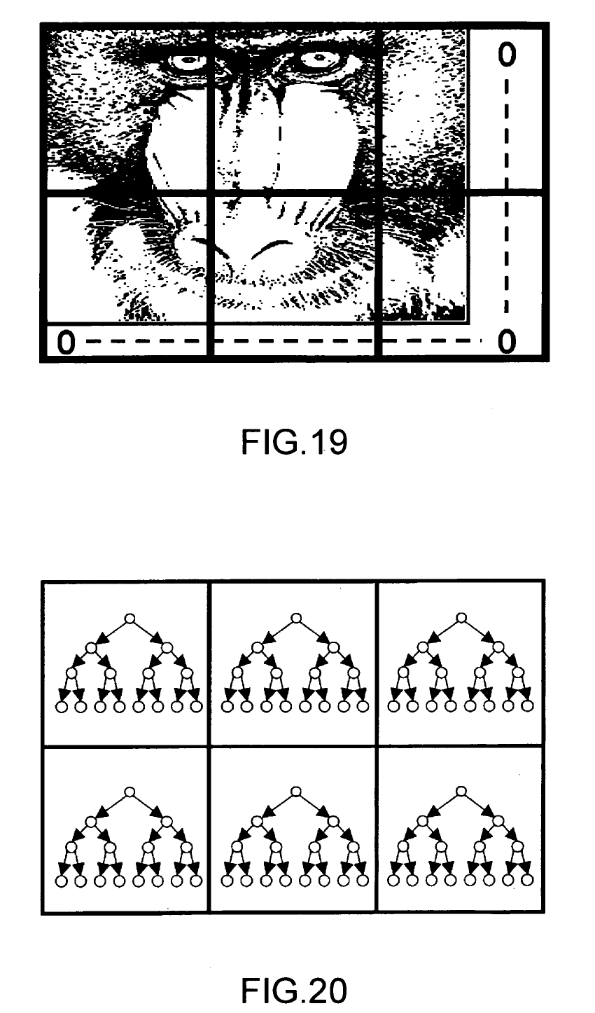

As a result of the above processing, as shown in, for example, FIG. 19, when a certain image is divided into a plurality of square areas, each square area is converted into a binary tree shown in FIG. 20.

In order to transmit and record image data represented as a binary tree, it is necessary to convert the image into a one-dimensional data sequence. There may be several methods for the sequence. For example, the following two types of methods are possible.

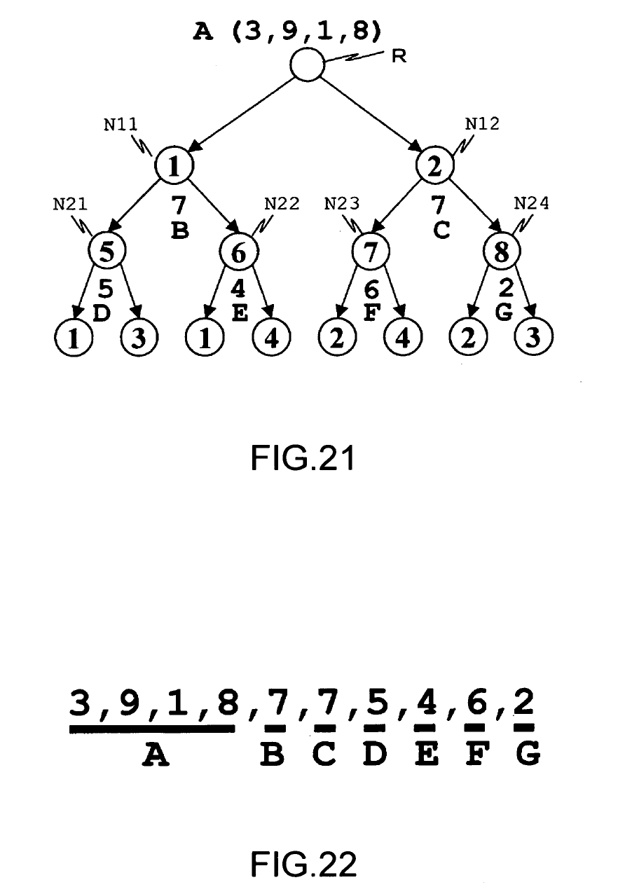

FIG. 21 shows an output method in which the widthwise direction of the binary tree takes priority. In this method, data is one-dimensionalized in the order indicated by letters A, B, C, . . . below the numerals (alphabetical order). For example, first, data A of the square (the pixel values of the four vertexes) is output as the root R; thereafter, data (the pixel values of the midpoints of the hypotenuses) B and C of nodes N11 and N12 of the same depth at the lower order of this root R are output; and thereafter, data (the pixel values of the midpoints of the hypotenuses) D, E, F, and G of nodes N21, N22, N23, and N24 of the same depth at the lower order of the nodes N11 and N12 are output.

FIG. 22 shows the results of the data which is formed into one dimension by this method, and the pixel values corresponding to the respective letters A, B, C, . . . are output in the order of the letters A, B, C, . . . .

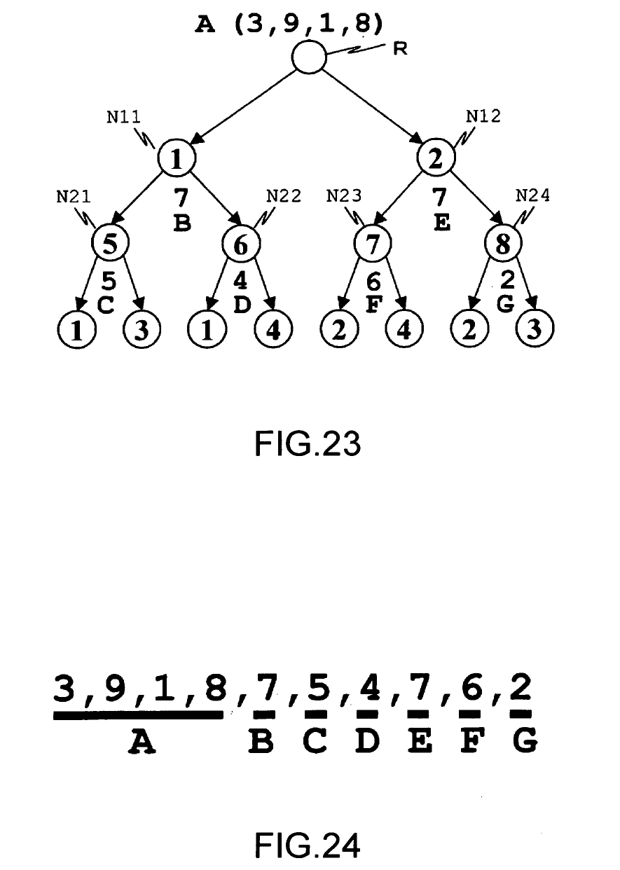

FIG. 23 shows an output method in which the depth direction of a binary tree takes priority. In this method, also, similarly to FIG. 21, the output sequence is indicated by letters A, B, C, . . . In this case, after the data A of the root R is output, the data B of the node N11 is output, and thereafter, the data C of the node N21 at a lower order with respect to that is output. In this manner, when the output up to reaching the bottom of the binary tree is performed, the data D of the node N22 is output. Then, the data output sequence is such that, this time, the data E of the node N12 is output, and next, the data F of the node N23 at a lower order with respect to the node N12 is output.

FIG. 24 shows the results of the data which is one-dimensionalized by this method, and pixel values corresponding to the letters A, B, C, . . . are output in the order of the letters A, B, C, . . . .

In the manner described above, the process of coding the image data to be processed is terminated. The data coded thereby has a data structure of a binary tree shown in, for example, FIG. 21 or 23, and based on the binary tree, the data is output in the data format shown in FIG. 22 or 24.

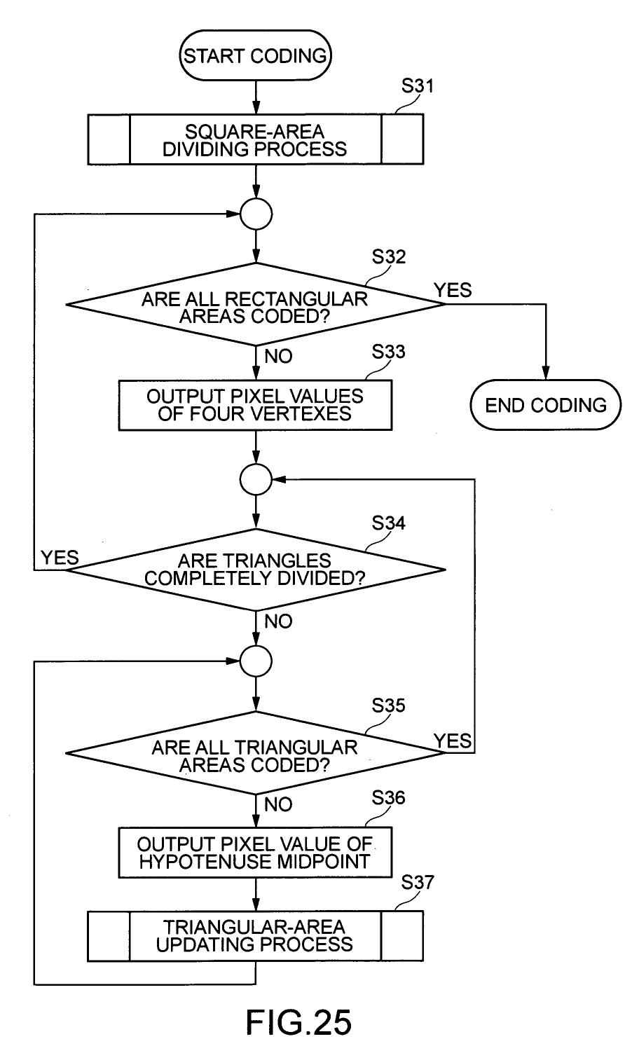

The summary of the contents described above is shown in the flowchart of FIG. 25. Since the details of each section are described above, only a brief overview is described below.

In FIG. 25, initially, a square-area dividing process is performed (step S31). This is a process such that, as described with reference to FIGS. 3(a) to 6, image data to be processed is divided into one or more square areas, and a coding process is performed on each square obtained by this square-area dividing process. It is determined whether or not all the square areas are coded (step S32). If all the square areas are coded, the processing is terminated, otherwise, the pixel values of the four vertexes of the square are output (step S33).

Then, it is determined whether or not the triangle dividing process is terminated (step S34). If the triangle dividing process is terminated, the process returns to step S32, and if the triangle dividing process is not terminated, it is determined whether or not all the triangles are coded (step S35). At this step, if all the triangles are not completely coded, the pixel value of the midpoint of the hypotenuse is output (step S36), a triangular-area updating process is performed (step S37), and the process returns to step S35.

If all the triangles are completely coded, if the triangle dividing process is terminated, and if all the square areas are completely coded, the coding process on that image is terminated.

As is described above, the first exemplary embodiment describes processing of coding image data to be processed. The general processing is such that image data to be processed is extracted as a square area, the extracted square is recurrently divided into triangular areas, and the pixel values of the three vertexes of each of the obtained triangular areas and the pixel value of the midpoint of the hypotenuse thereof are obtained. At this time, the type of each triangle obtained by a recurrent dividing process can be automatically determined according to a division sequence as long as the manner of dividing the original square is determined in advance. Furthermore, for the pixel values of the vertexes of each triangle, the pixel values possessed by the square can be succeeded as they are. Therefore, if the pixel value of the midpoint of the hypotenuse is determined from the original square, the entire image can be represented by the binary tree shown in FIG. 18, and it can be one-dimensionized and output, as shown in FIGS. 21 and 22 or in FIGS. 23 and 24.

In the manner described above, according to the present invention, a less amount of data to be stored to represent image data to be processed is required, thereby making it possible to greatly simplify computations and to greatly reduce the amount of memory used.

### Second Exemplary Embodiment

The second exemplary embodiment describes processing of decoding data coded by the above-described first exemplary embodiment.

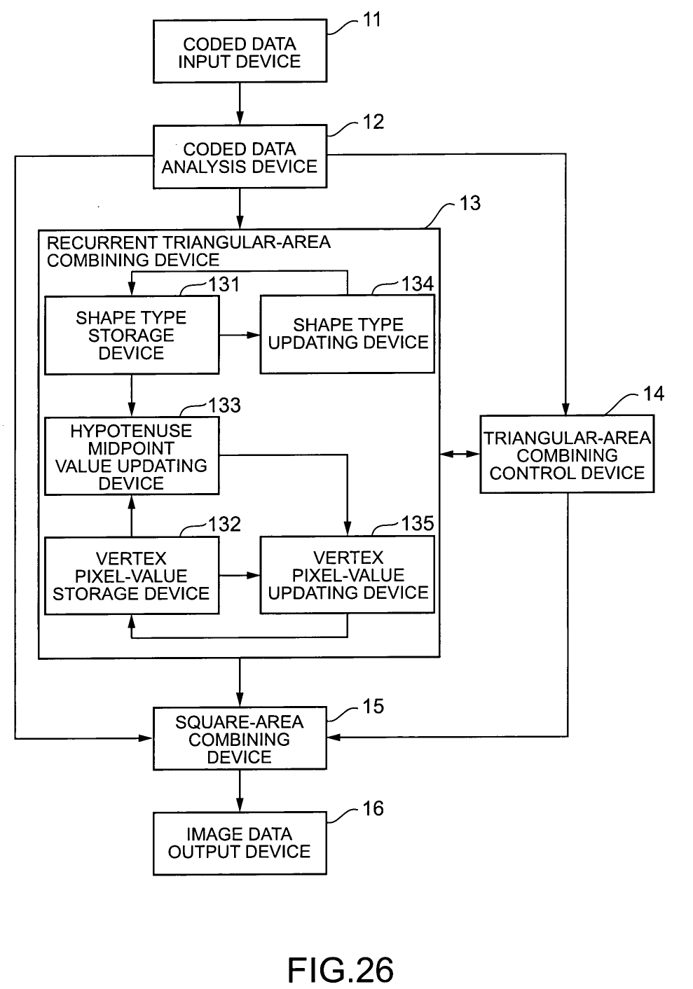

FIG. 26 shows the second exemplary embodiment of an image processing device according to the present invention, and shows the configuration on the decoding side with respect to the first exemplary embodiment. When the configuration on this decoding side is broadly classified, the image processing device includes a coded data input device 11, a coded data analysis device 12, a recurrent triangular-area combining device 13, a triangular-area combining control device 14, a square-area combining device 15, and an image data output device 16.

The recurrent triangular-area combining device 13 includes at least a shape type storage device 131 to store triangle types of divided triangles (since eight types from #1 type to #8 type are used in the above-described first exemplary embodiment, in this second exemplary embodiment, also, eight types from #1 type to #8 type are used); a vertex pixel-value storage device 132 to store the pixel values of the three vertexes of a triangle and the pixel value of the midpoint of the hypotenuse thereof; a hypotenuse midpoint pixel-value obtaining device 133 to supplement the pixel value of the midpoint of the hypotenuse of a triangle, a shape type updating device 134 to update the triangle type by using the succession rule of FIG. 11; and a vertex pixel-value updating device 135 to update the pixel values of the three vertexes of a triangle and the pixel value of the midpoint of the hypotenuse thereof.

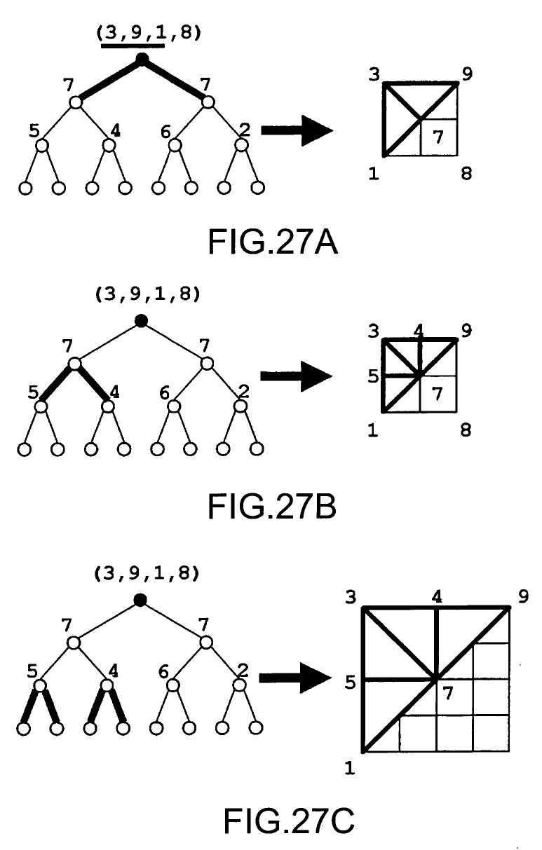

Furthermore, the coded data input device 11 inputs, from a transmission line or a storage medium, coded data (for example, the coded data shown in FIGS. 22 and 24) from the coded data output device 6 shown in FIG. 1. As the coded data input to the coded data input device 11, as shown in FIG. 27A, the pixel values of the four vertexes of a square are input at first. For example, as the coded data, if FIG. 22 is used as an example, first, the portion of the underlined portion A in the coded data shown in FIG. 22 is read, and the pixel values (3, 9, 1, 8) of the four vertexes of the square are reconstructed. Thereafter, the pixel value (7) corresponding to the underlined portion B of FIG. 22 is read, and the thickened-line portion of the binary tree shown in FIG. 27A is reconstructed. It corresponds to the thickened-line portion of the square area. Hereafter, data (pixel values) is read one after another, and the thickened-line portion of the binary tree of the data is reconstructed, as shown in FIGS. 27B and 27C, thereby reconstructing the thickened-line portion of the square area.

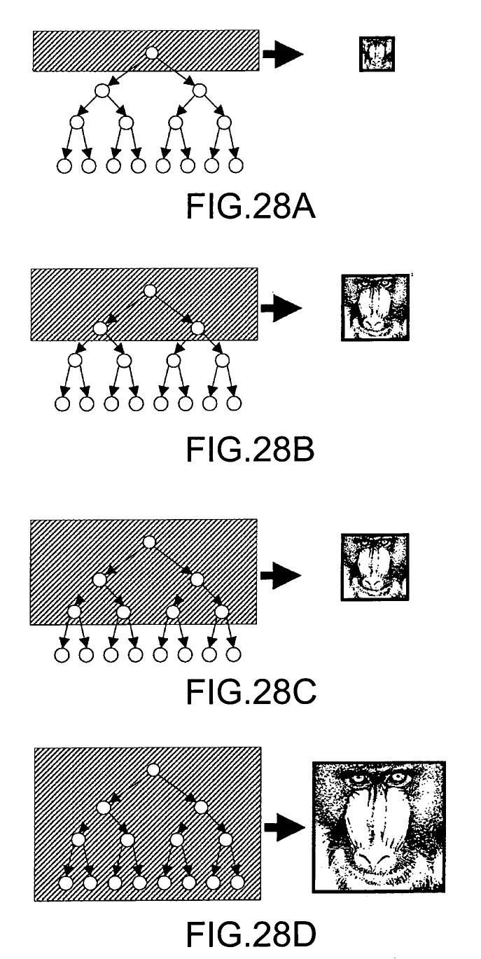

FIG. 28 illustrates the processing contents of FIGS. 27A-27C from the viewpoint of progressive reconstruction. According to the coded data format shown in FIG. 22, reconstruction is performed in sequence for each hierarchy of the binary tree in such a manner that, at first, only the high-order layer of the binary tree is reconstructed as shown in FIG. 28A, and then the next hierarchy of the binary tree is reconstructed as shown in FIG. 28B, and further, the next hierarchy of the binary tree is reconstructed as shown in FIG. 28C. Finally, as shown in FIG. 28D, the reconstruction up to the bottom of the binary tree is performed.

As a result, the image to be processed is formed to be larger or its resolution is increased in sequence as the reconstruction for each hierarchy of the binary tree proceeds.

For example, when attempts are made to expand a small image having a small amount of data, such as that shown in FIG. 28A, as it is in a manner similar to the final image, an image having a low resolution is formed. That is, from the standpoint of how the image is viewed, it may be considered that the entire image is displayed in a reduced manner. Alternatively, when the image size is made the same as that of the original data, it may also be considered that the image is shown with a lower resolution.

If it is considered that the entire image is represented with a lower resolution, each triangular area is expanded. At this time, the interior of the triangular area can also be determined by interpolation as a plane using the pixel values of the three vertexes thereof. of course, it is also possible to perform a higher-order estimation by using the data of the triangular areas in the vicinity thereof.

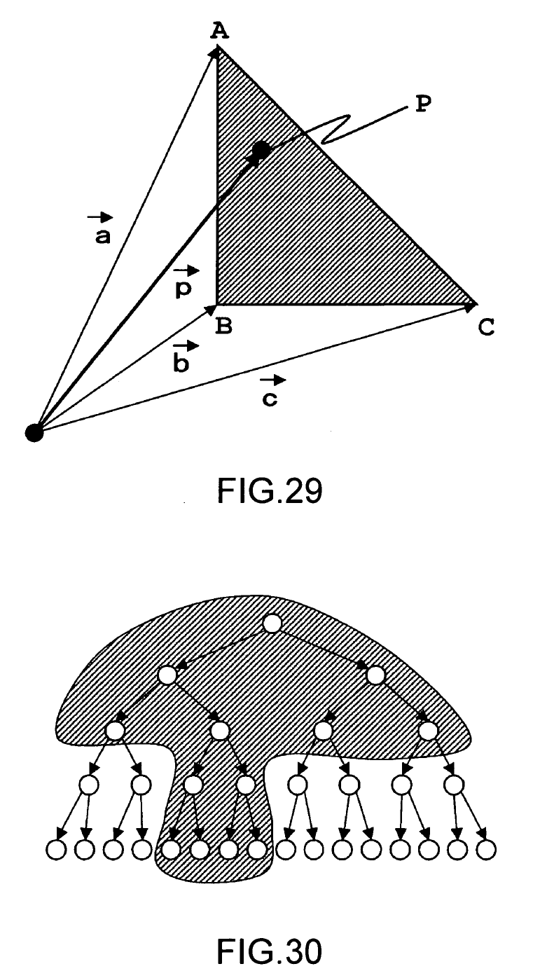

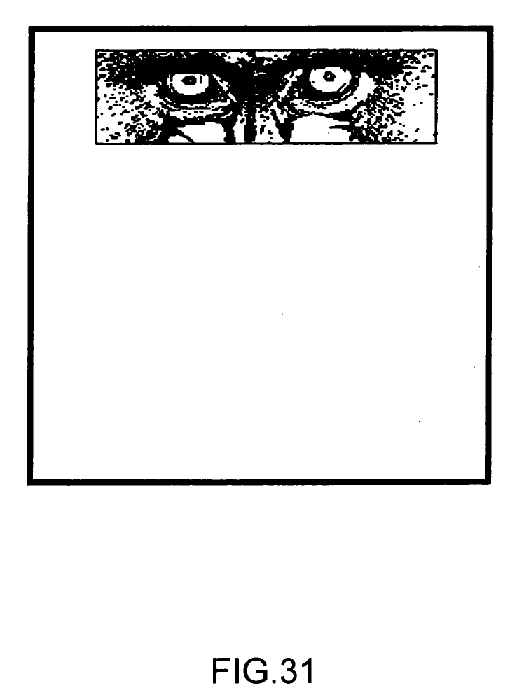

In a case where interpolation as a plane is performed by using the pixel values of the three vertexes, a method shown in FIG. 29 may be used. FIG. 29 is described briefly below. The position vector to the three vertexes of the triangle is denoted as a, b, and c (“→” is assigned above each of a, b, and c), and the pixel values at these vertexes are denoted as A, B, and C. Here, it is assumed that the position vector at the position where the pixel value should be determined is denoted as p (“→” is assigned above p), and this position vector p (“→” is assigned above p) is given by

Equation [1 ]

\vec{p}=x\vec{a}+y\vec{b}+z\vec{c} (1)

In order that the position p at which the pixel value should be determined is within the triangular area, the following conditions must be satisfied: x, y, and z are pixel information of 0 or more, and

x+y+z=1 (2)

By using x, y, and z, the pixel value P at the position p is determined by the following:

P=xA+yB+zC (3)

The method for one-dimensionalizing data, shown in FIGS. 21 and 22 or in FIGS. 23 and 24, in the above-described first exemplary embodiment, is irrespective of the contents of the image data. However, by changing the coding method or the method of reading data from a storage medium, an ROI (Region Of Interest) can be formed into a higher image quality with priority.

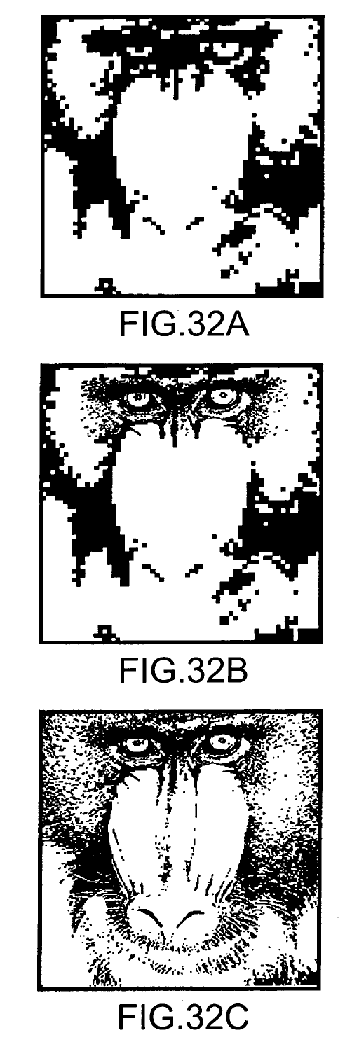

For example, as shown in FIG. 30, it is assumed that the oblique-lined portion within the binary tree is to be transmitted or read. The deep portion of the hierarchy of this binary tree is assumed to be the eye portion of the ape face image as an image example used in the first exemplary embodiment and the second exemplary embodiment of the present invention. In this case, in the reconstruction process of the shallow hierarchy of the binary tree of FIG. 30, a display is possible such that, as shown in FIG. 32A, regarding the image whose entire image is reconstructed with a low resolution, as the hierarchy becomes deeper, formation into a higher resolution proceeds starting with the eye portion as shown in FIG. 32B, and finally, the entirety is formed into a higher resolution as shown in FIG. 32C. Of course, such a display can be stopped in the middle of processing.

In this manner, by setting the priority on the basis of the region of interest (ROI) in the order of the transmission or the reading of data represented by a binary tree, only a specific portion within the entire image can be displayed with a high resolution more quickly.

As a result, in a case where desired image data is to be searched for from among a lot of image data or image data is to be classified, only the feature portions of individual images can be displayed with a high resolution more quickly, making it possible to efficiently perform searching and classification. At this time, it is also possible to stop the display process when the contents of individual images are known, so that the subsequent display is not performed.

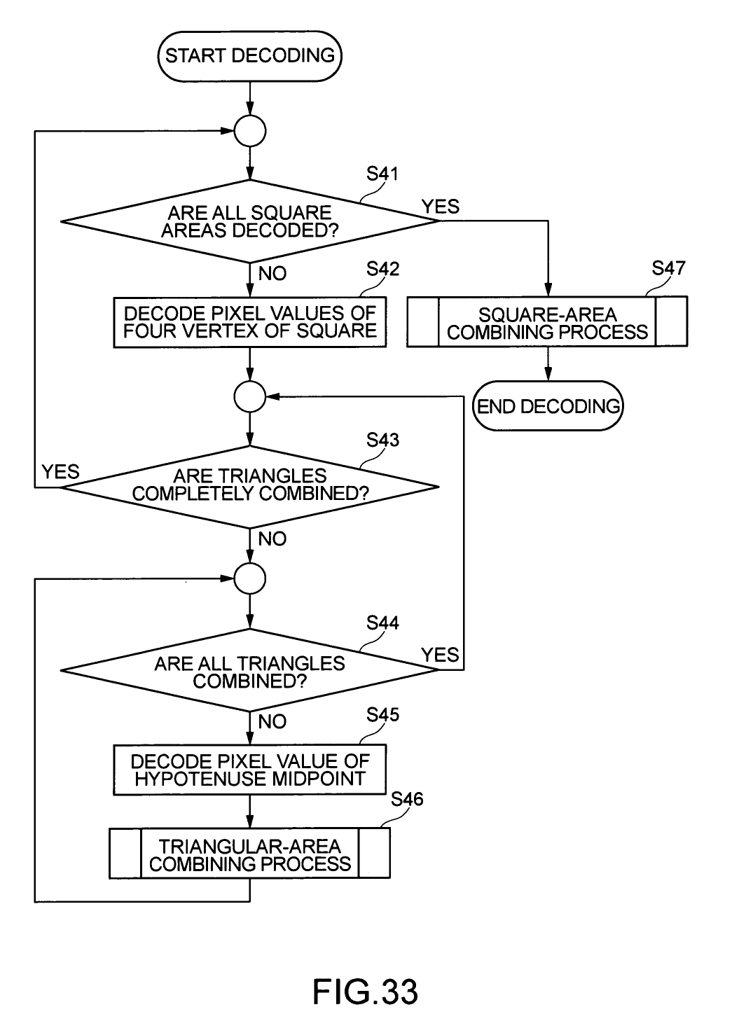

The summary of the processing contents (decoding processing contents) of the second exemplary embodiment described above is shown in the flowchart of FIG. 33. Since the details of each section have been described, a brief overview is described here.

In FIG. 33, initially, it is determined whether or not all the square areas are decoded (step S41). If all the square areas are not completely decoded, the pixel values of the four vertexes of the square are decoded (step S42). Then, it is determined whether the triangle combining process is terminated (step S43). If the triangle combining process is terminated, the process returns to step S41, and if it is not terminated, it is determined whether all the triangles are completely combined (step S44).

Then, if all the triangles are not completely combined, the pixel value of the midpoint of the hypotenuse is decoded (step S45), a triangular-area combining process is performed (step S46), and the process returns to step S44.

Then, if all the square areas are completely decoded (step S41), a square-area combining process is performed (step S47), and the decoding process is terminated.

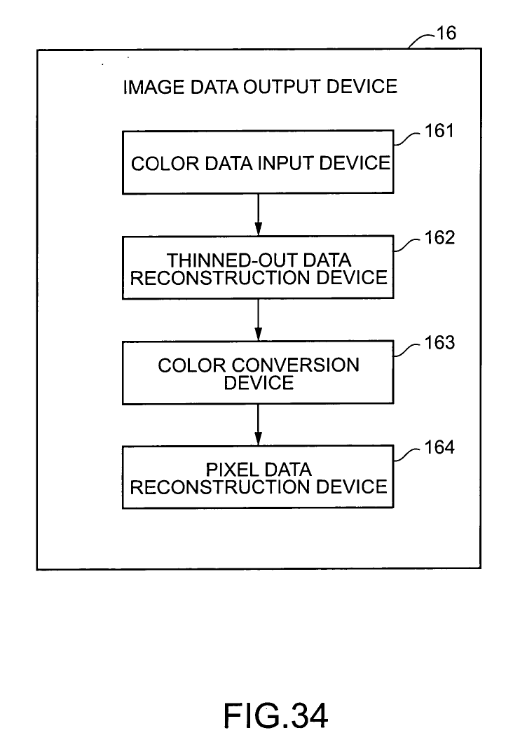

The image data on which the square-area combining process is performed in step S47 is output by the image data output device 16 shown in FIG. 26. The image data output device 16, as shown in FIG. 34, includes a color data input device 161, thinned-out data reconstruction device 162, a color conversion device 163, and pixel data reconstruction device 164. The image data output device 16 excludes, from the reconstructed image data, the data supplemented to make the image width and the image height to be an integral multiple of one side of the square, and outputs the original image. For the image data output process performed by the image data output device 16, some kind of post processing, such as a noise reduction process, may be included.

### Third Exemplary Embodiment

In the first exemplary embodiment and the second exemplary embodiment which are described above, in a case where the image data to be processed is not a square, when a square area is to be extracted from the image data, as described with reference to FIG. 6, a plurality of square areas are obtained by dividing the image data into a plurality of square areas. The third exemplary embodiment describes an example in which one square image is generated by performing image processing such that image data which is not a square is transformed into a square. The third exemplary embodiment is described below.

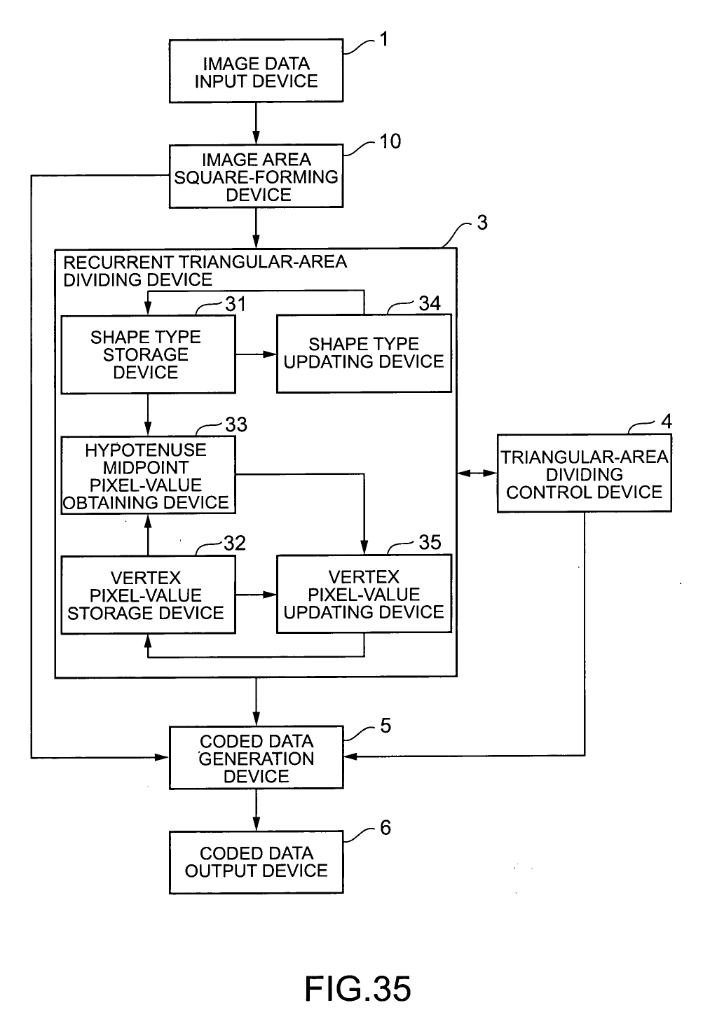

FIG. 35 illustrates an image processing device according to the third exemplary embodiment of the present invention, and shows the configuration on the coding side. The configuration on the coding side shown in FIG. 35 is such that, when compared to the configuration of FIG. 1 described in the above-described first exemplary embodiment, as the component element, the square-area dividing device 2 (see FIG. 1) is replaced with the image area square-forming device 10 (see FIG. 35), and the remaining configuration is the same as that of FIG. 1. Accordingly, the same components are designated with the same reference numerals, and, descriptions of the components are omitted here.

The image area square-forming device 10 performs image processing such that image data to be processed is transformed into a square, thereby an image which is not a square can be formed into a square image. Therefore, in this case, rather than generating a plurality of square areas with respect to the image data to be processed, one square area is generated.

As a result, when compared to the first exemplary embodiment in which one or more square areas need to be handled, in the third exemplary embodiment, one square area is always handled. In this manner, by forming the image data to be processed into one square area, although in the first exemplary embodiment, binary trees shown in FIG. 18 are provided in such a manner as to correspond to the respective squares (see FIG. 20), in the third exemplary embodiment, only one binary tree corresponding to one square needs to be generated.

Since the coding processes, etc., are described in the first exemplary embodiment, descriptions thereof are omitted below.

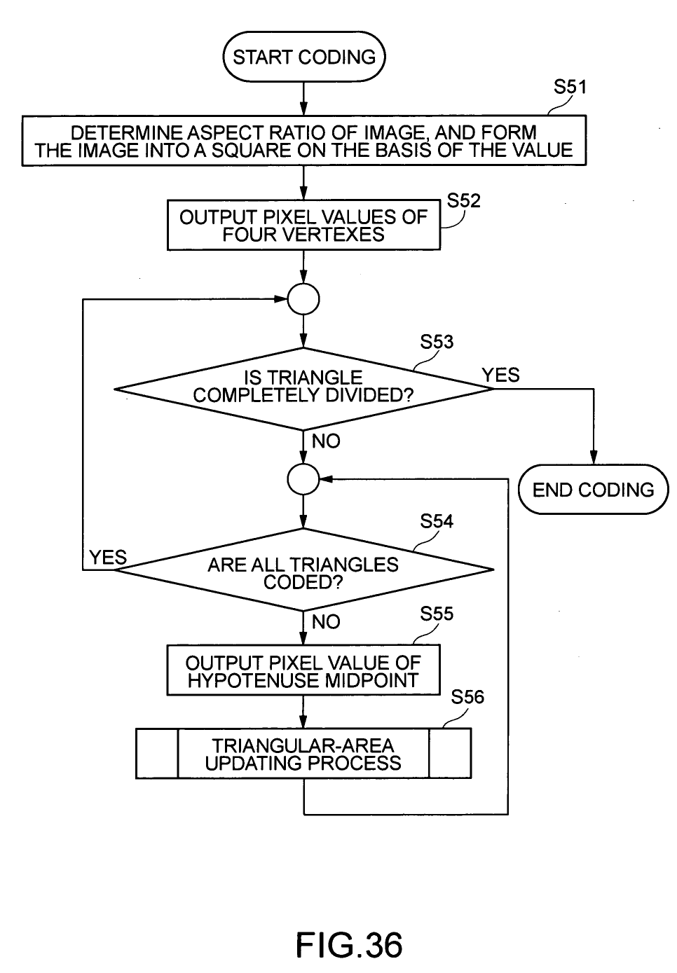

The summary of the processing contents of the third exemplary embodiment is shown in the flowchart of FIG. 36. Since the details of each section are described below, a brief overview is described below.

In FIG. 36, initially, as the processing of forming an image to be processed into a square, the aspect ratio of the subject image is determined, and the image is formed into a square on the basis of the determined value (step S51). Next, the pixel values of the four vertexes of the square-formed image are output (step S52).

Then, it is determined whether or not the triangle dividing process is terminated (step S53). If the triangle dividing process is not terminated, it is determined whether all the triangles are coded (step S54).

Here, if all the triangles are not completely coded, the pixel value of the midpoint of the hypotenuse is output (step S55), a triangular-area updating process is performed (step S56), and the process returns to step S54.

Then, if all the triangles are completely coded and the triangle dividing process is terminated, the series of coding processes is terminated.

### Fourth Exemplary Embodiment

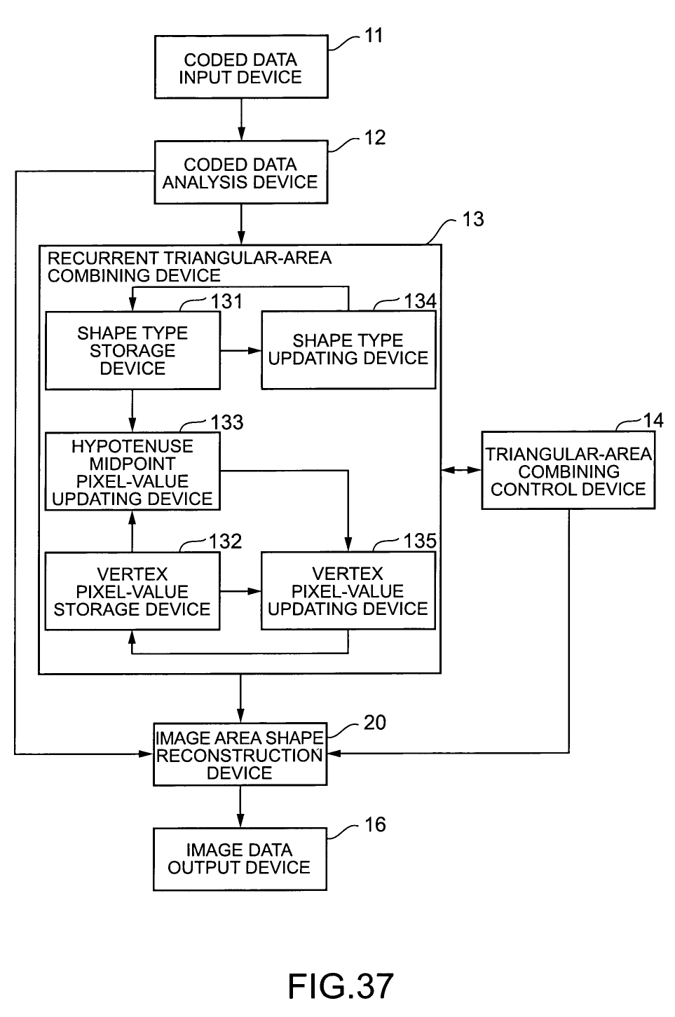

FIG. 37 illustrates an image processing device according to a fourth exemplary embodiment of the present invention, and shows the configuration on the decoding side with respect to the third exemplary embodiment. The configuration on the decoding side shown in FIG. 37 is such that, when compared to the configuration of FIG. 26 described in the above-described second exemplary embodiment (decoding with respect to the first exemplary embodiment), as the component element, only the square-area combining device 15 (see FIG. 26) is replaced with the image area shape reconstruction device 20 (see FIG. 37), and the remaining configuration is the same as that of FIG. 26. Accordingly, the same components are designated with the same reference numerals, and descriptions of the components are omitted below.

In the fourth exemplary embodiment, since image processing is performed on the coding side in order to form an image into one square, on this decoding side, a process of decoding the image, which is formed into a square, into the original image is performed by the image area shape reconstruction device 20. Since the decoding processes other than that are similar to those described in the second exemplary embodiment, descriptions thereof are omitted below.

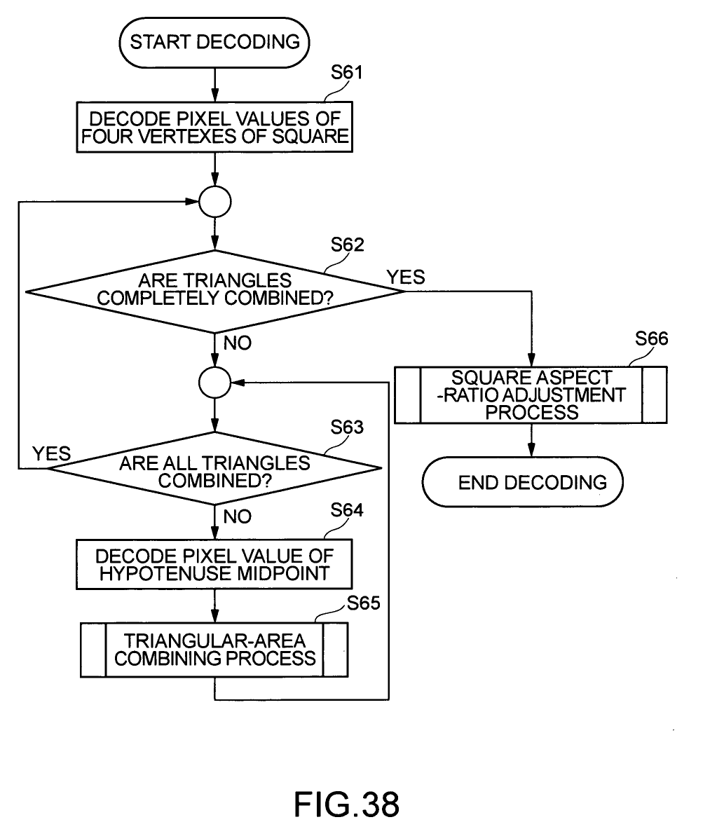

The summary of the processing contents of the fourth exemplary embodiment described above is shown in the flowchart of FIG. 38. Since the details of each section are described above, a brief overview is described below.

In FIG. 38, initially, the pixel values of the four vertexes of the square are decoded (step S61). Then, it is determined whether the triangle combining process is terminated (step S62). If the triangle combining process is not terminated, it is determined whether all the triangles are completely combined (step S63). Then, if all the triangles are not completely combined, the pixel value of the midpoint of the hypotenuse is decoded (step S64), a triangular-area combining process is performed (step S65), and the process returns to step S63.

On the other hand, if the triangle combining process in step S62 is terminated, a square aspect-ratio adjustment process (step S66) is performed as a process of reconstructing into the aspect ratio of the original image, and the decoding process is terminated.

The present invention is not limited to each of the above-described exemplary embodiments, and can be embodied in various ways within the spirit and scope of the present invention. In the present invention, a processing program in which a processing procedure for realizing the present invention which has been described above is described may be prepared, and the processing program may be recorded on a recording medium, such as a floppy disk, an optical disk, and/or a hard disk, for example, and the present invention includes a recording medium on which the processing program is recorded. Furthermore, the processing program may be obtained from a network.

### Exemplary Advantages

As is described above, according to the present invention, when image data to be processed is to be coded, the image data to be processed is divided into one or more square areas, the extracted square is recurrently divided into triangular areas, and the pixel information of the three vertexes of each of the obtained triangular areas (hereinafter “pixel values”), and the pixel value of the midpoint of the hypotenuse thereof are obtained.

At this time, the type of each triangle obtained by the recurrent dividing process can be automatically determined according to a division sequence as long as the manner of dividing the original square is determined in advance. Furthermore, for the pixel values of the vertexes of each triangle, the pixel values possessed by the square can be succeeded as they are, and therefore the pixel value of the midpoint of the hypotenuse can also be determined from the original square. Then, the types of square areas by such a recurrent triangular-area dividing process and the pixel values to be stored can be represented by a binary tree, and these can be output as one-dimensionalized data on the basis of the binary tree.

According to the above, when image data to be processed is to be coded, a very small amount of data to be stored or transmitted when coding is performed is required. This makes it possible to greatly simplify computations and to greatly reduce the amount of memory used.

Also, when the data coded in this manner is to be decoded, similarly to coding, it is possible to require a very small amount of data which should be stored for decoding, thereby making it possible to greatly simplify computations and to greatly reduce the amount of memory used. Furthermore, by setting the priority in the order of transmission or reading of data represented by a binary tree on the basis of a region of interest of the image, only a specific portion within the entire image can be displayed with a high resolution more quickly. As a result, in a case where desired image data is to be searched for from among a lot of image data or image data is to be classified, only the feature portions of individual images can be displayed with a high resolution more quickly, making it possible to efficiently perform searching and classification processes.

What is claimed is:

1. An image processing method of dividing an image to be processed into one or more square areas, dividing each square area into triangular areas, and coding the divided triangular area, the image processing method comprising:
inputting the image to be processed and storing the image;
dividing the input image into one or more square areas;
recurrently dividing each divided square area into triangular areas;
coding the divided triangular areas; and
outputting the generated coded data.

2. The image processing method according to claim 1, the number of pixels contained in one side of the square area generated in the dividing the input image being 2 raised to the N-th power+1 (where N is a natural number).

3. The image processing method according to claim 1, the recurrently dividing including storing the type of the shape of a triangular area, storing the pixel information of the vertexes and the hypotenuse midpoint of the triangular area, obtaining the pixel information of the hypotenuse midpoint of the triangular area, updating the type of the shape of the triangular area, and updating the pixel information of the vertexes and the hypotenuse midpoint of the triangular area.

4. An image processing method of recurrently dividing each square area of an image which is divided into one or more square areas into triangular areas and decoding the coded data obtained by coding the divided triangular areas, the image processing method comprising:
inputting the coded image data;
analyzing the input coded data;
recurrently combining triangular areas on the basis of the analyzed coded data;
combining a square area on the basis of the combined triangular areas; and
reconstructing the image data from the combined square area and outputting the image data.

5. The image processing method according to claim 4, the number of pixels contained in one side of the square area generated in the combining a square-area being 2 raised to the N-th power+1 (where N is a natural number).

6. The image processing method according to claim 4, the recurrently combining including storing the type of the shape of a triangular area, storing the pixel information of the vertexes and the hypotenuse midpoint of the triangular area, obtaining the pixel information of the hypotenuse midpoint of the triangular area, updating the type of the shape of the triangular area, and updating the pixel information of the vertexes and the hypotenuse midpoint of the triangular area.

7. An image processing method of transforming an image to be processed into one square area, dividing the square area into triangular areas, and coding the divided triangular areas, the image processing method comprising:
inputting and storing an image;
transforming the input image into one square area;
recurrently dividing the square-formed area into triangular areas;
coding the divided triangular areas; and
outputting the generated coded data.

8. The image processing method according to claim 7, the number of pixels contained in one side of the square area generated in the transforming being 2 raised to the N-th power+1 (where N is a natural number).

9. The image processing method according to claim 7, the recurrently dividing including storing the type of the shape of a triangular area, storing the pixel information of the vertexes and the hypotenuse midpoint of the triangular area, obtaining the pixel information of the hypotenuse midpoint of the triangular area, updating the type of the shape of the triangular area, and updating the pixel information of the vertexes and the hypotenuse midpoint of the triangular area.

10. An image processing method of recurrently dividing an image which is transformed into one square area into triangular areas and decoding the coded data obtained by coding the divided triangular areas, the image processing method comprising:
inputting coded data;
analyzing the input coded data;
recurrently combining triangular areas on the basis of the analyzed coded data;
combining a square area on the basis of the combined triangular areas; and
transforming the combined square area into the original image data area.

11. The image processing method according to claim 10, the number of pixels contained in one side of the square area generated in the combining a square-area being 2 raised to the N-th power+1 (where N is a natural number).

12. The image processing method according to claim 10, the recurrently combining including storing the type of the shape of a triangular area, storing the pixel information of the vertexes and the hypotenuse midpoint of the triangular area, obtaining the pixel information of the hypotenuse midpoint of the triangular area, updating the type of the shape of the triangular area, and updating the pixel information of the vertexes and the hypotenuse midpoint of the triangular area.

13. An image processing device to divide an image to be processed into one or more square areas, to divide each square area into triangular areas, and to code the divided triangular areas, the image processing device comprising:
an image input device to input an image to be processed and to store the image;
a square-area dividing device to divide the input image into one or more square areas;
a recurrent triangular-area dividing device to recurrently divide each divided square area into triangular areas;
a coded data generation device to code the divided triangular areas; and
a coded data output device to output the generated coded data.

14. The image processing device according to claim 13, the number of pixels contained in one side of the square area generated by the square-area dividing device being 2 raised to the N-th power+1 (where N is a natural number).

15. The image processing device according to claim 13, the recurrent triangular-area dividing device including a shape type storage device to store the type of the shape of a triangular area, a vertex pixel information storage device to store the pixel information of the vertexes and the hypotenuse midpoint of the triangular area, a hypotenuse midpoint pixel information obtaining device to obtain the pixel information of the hypotenuse midpoint of the triangular area, a shape type updating device to update the type of the shape of the triangular area, and a vertex pixel information updating device to update the pixel information of the vertexes and the hypotenuse midpoint of the triangular area.

16. An image processing device to recurrently divide each square area of an image which is divided into one or more square areas and to decode the coded data obtained by coding the divided triangular areas, the image processing device comprising:
a coded data input device to input coded data;
a coded data analysis device to analyze the input coded data;
a recurrent triangular-area combining device to recurrently combine triangular areas on the basis of the analyzed coded data;
a square-area combining device to combine a square area on the basis of the combined triangular areas; and
an image data output device to output image data from the combined square area.

17. The image processing device according to claim 16, the number of pixels contained in one side of the square area generated by the square-area combining device being 2 raised to the N-th power+1 (where N is a natural number).

18. The image processing device according to claim 16, the recurrent triangular-area combining device including a shape type storage device to store the type of the shape of a triangular area, a vertex pixel information storage device to store the pixel information of the vertexes and the hypotenuse midpoint of the triangular area, a hypotenuse midpoint pixel information obtaining device to obtain the pixel information of the hypotenuse midpoint of the triangular area, a shape type updating device to update the type of the shape of the triangular area, and a vertex pixel information updating device to update the pixel information of the vertexes and the hypotenuse midpoint of the triangular area.

19. An image processing device to transform an image to be processed into one square area, to divide the square area into triangular areas, and to code the divided triangular areas, the image processing device comprising:
an image input device to input and store an image;
an image area square-forming device to transform the input image into one square area;
a recurrent triangular-area dividing device to recurrently divide the square-formed area into triangular areas;
a coded data generation device to code the divided triangular areas; and
a coded data output device to output the generated coded data.

20. The image processing device according to claim 19, the number of pixels contained in one side of the square area generated by the image area square-forming device being 2 raised to the N-th power+1 (where N is a natural number).

21. The image processing device according to claim 19, the recurrent triangular-area dividing device including a shape type storage device to store the type of the shape of a triangular area, a vertex pixel information storage device to store the pixel information of the vertexes and the hypotenuse midpoint of the triangular area, a hypotenuse midpoint pixel information obtaining device to obtain the pixel information of the hypotenuse midpoint of the triangular area, a shape type updating device to update the type of the shape of the triangular area, and a vertex pixel information updating device to update the pixel information of the vertexes and the hypotenuse midpoint of the triangular area.

22. An image processing device to recurrently divide an image which is transformed into one square area into triangular areas and to decode the coded data obtained by coding the divided triangular areas, the image processing device comprising:
a coded data input device to input coded data;
a coded data analysis device to analyze the input coded data;
a recurrent triangular-area combining device to recurrently combine triangular areas on the basis of the analyzed coded data;
a square-area combining device to combine a square area on the basis of the combined triangular areas; and
an image data output device to transfer the combined square area into the original image data area.

23. The image processing device according to claim 22, the number of pixels contained in one side of the square area generated by the square-area combining device being 2 raised to the N-th power+1 (where N is a natural number).

24. The image processing device according to claim 22, the recurrent triangular-area combining device including a shape type storage device to store the type of the shape of a triangular area, a vertex pixel information storage device to store the pixel information of the vertexes and the hypotenuse midpoint of the triangular area, a hypotenuse midpoint pixel information obtaining device to obtain the pixel information of the hypotenuse midpoint of the triangular area, a shape type updating device to update the type of the shape of the triangular area, and a vertex pixel information updating device to update the pixel information of the vertexes and the hypotenuse midpoint of the triangular area.

25. An image processing program to allow a computer to perform image processing to divide an image to be processed into one or more square areas, to divide each square area into triangular areas, and to code the divided triangular area, the image processing program comprising:
an image input program for inputting the image to be processed and storing the image;
a square-area dividing program for dividing the input image into one or more square areas;
a recurrent triangular-area dividing program for recurrently dividing each divided square area into triangular areas;
a coded data generation program for coding the divided triangular areas; and
a coded data output program for outputting the generated coded data.

26. The image processing program according to claim 25, the number of pixels contained in one side of the square area generated in the square-area dividing program being 2 raised to the N-th power +1 (where N is a natural number).

27. The image processing program according to claim 25, the recurrent triangular-area dividing program including a shape type storing program for storing the type of the shape of a triangular area, a vertex pixel information storing program for storing the pixel information of the vertexes and the hypotenuse midpoint of the triangular area, a hypotenuse midpoint pixel information obtaining program for obtaining the pixel information of the hypotenuse midpoint of the triangular area, a shape type updating program for updating the type of the shape of the triangular area, and a vertex pixel information updating program for updating the pixel information of the vertexes and the hypotenuse midpoint of the triangular area.

28. An image processing program to allow a computer to perform image processing to recurrently divide each square area of an image which is divided into one or more square areas into triangular areas and to decode the coded data obtained by coding the divided triangular areas, the image processing program comprising:
a coded data input program for inputting the coded image data;
a coded data analysis program for analyzing the input coded data;
a recurrent triangular-area combining program for recurrently combining triangular areas on the basis of the analyzed coded data;
a square-area combining program for combining a square area on the basis of the combined triangular areas; and
an image data output program for reconstructing the image data from the combined square area and outputting the image data.

29. The image processing program according to claim 28, the number of pixels contained in one side of the square area generated in the square-area combining program being 2 raised to the N-th power+1 (where N is a natural number).

30. The image processing program according to claim 28, the recurrent triangular-area combining program including a shape type storing program for storing the type of the shape of a triangular area, a vertex pixel information storing program for storing the pixel information of the vertexes and the hypotenuse midpoint of the triangular area, a hypotenuse midpoint pixel information obtaining program for obtaining the pixel information of the hypotenuse midpoint of the triangular area, a shape type updating program for updating the type of the shape of the triangular area, and a vertex pixel information updating program for updating the pixel information of the vertexes and the hypotenuse midpoint of the triangular area.

31. An image processing program to allow a computer to perform image processing to transform an image to be processed into one square area, to divide the square area into triangular areas, and to code the divided triangular areas, the image processing program comprising:
an image input program for inputting and storing an image;
an image area square-forming program for transforming the input image into one square area;
a recurrent triangular-area dividing program for recurrently dividing the square-formed area into triangular areas;
a coded data generation program for coding the divided triangular areas; and
a coded data output program for outputting the generated coded data.

32. The image processing program according to claim 31, the number of pixels contained in one side of the square area generated in the image area square-forming program being 2 raised to the N-th power+1 (where N is a natural number).

33. The image processing program according to claim 31, the recurrent triangular-area dividing program including a shape type storing program for storing the type of the shape of a triangular area, a vertex pixel information storing program for storing the pixel information of the vertexes and the hypotenuse midpoint of the triangular area, a hypotenuse midpoint pixel information obtaining program for obtaining the pixel information of the hypotenuse midpoint of the triangular area, a shape type updating program for updating the type of the shape of the triangular area, and a vertex pixel information updating program for updating the pixel information of the vertexes and the hypotenuse midpoint of the triangular area.

34. An image processing program to allow a computer to perform image processing to recurrently divide an image which is transformed into one square area into triangular areas and to decode the coded data obtained by coding the divided triangular areas, the image processing program comprising:
a coded data input program for inputting coded data;
a coded data analysis program for analyzing the input coded data;
a recurrent triangular-area combining program for recurrently combining triangular areas on the basis of the analyzed coded data;
a square-area combining program for combining a square area on the basis of the combined triangular areas; and
an image data output program for transforming the combined square area into the original image data area.

35. The image processing program according to claim 34, the number of pixels contained in one side of the square area generated in the square-area combining program being 2 raised to the N-th power+1 (where N is a natural number).

36. The image processing program according to claim 34, the recurrent triangular-area combining program including a shape type storing program for storing the type of the shape of a triangular area, a vertex pixel information storing program for storing the pixel information of the vertexes and the hypotenuse midpoint of the triangular area, a hypotenuse midpoint pixel information obtaining program for obtaining the pixel information of the hypotenuse midpoint of the triangular area, a shape type updating program for updating the type of the shape of the triangular area, and a vertex pixel information updating program for updating the pixel information of the vertexes and the hypotenuse midpoint of the triangular area.
